(19) United States
(12) Patent Application Publication
(10) Pub. No.: US 2017/0135178 A1
(43) Pub. Date: May 11, 2017

(54) MULTI-COLOR MODULAR LIGHTING SYSTEM AND MULTI-EXPRESSION LIGHTING MODULE WITH SENSOR

(71) Applicants: Alan Sutton, Voorhees, NJ (US); Michael Chi Hang Yeung, Kowloon (HK)

(72) Inventors: Alan Sutton, Voorhees, NJ (US); Michael Chi Hang Yeung, Kowloon (HK)

(21) Appl. No.: 15/319,238

(22) PCT Filed: Jun. 17, 2015
(86) PCT No.: PCT/US15/36247

§ 371 Date: Dec. 15, 2016

Related U.S. Application Data
(60) Provisional application No. 62/013,879, filed on Jun. 18, 2014.
(60) Provisional application No. 62/081,382, filed on Nov. 18, 2014.

(51) Int. Cl. H05B 33/08; A41D 27/08; A63H 3/00; A63H 33/22; A43B 3/10; A43B 23/24; A41D 19/00; A42B 1/00; A41D 1/00; A63H 3/02; A43B 3/00; A47C 21/00; A47G 19/22; A44C 15/00; A45C 15/06; A45C 3/06; A45F 3/04; F21V 33/00; F21L 4/02; F21V 23/04; A63H 33/26

(52) U.S. Cl. CPC H05B 33/0872; A63H 33/26; A41D 27/085; A63H 3/006; A63H 33/22; A43B 3/102; A43B 23/24; A41D 19/0024; A42B 1/004; A41D 1/002; A63H 3/02; A43B 3/001; A47C 21/003; A47G 19/2227; A44C 15/0015; A45C 15/06; A45C 3/06; A45F 3/04; F21V 33/0008; F21L 4/02; F21V 23/0414; A47G 2019/2238; F21Y 2115/10

(57) ABSTRACT

A light emitting system for an article includes a switch that manually selects from multiple modes of operation for lights. The article may be a toy, slumber bed, backpack, wearable article, or light emitting system for receiving a container. One mode provides illumination and a second mode provides flashing and/or multicolor effects. Another lighting system includes a lighting module with a lighting circuit having a motion switch or other type of sensor, an electronic switch, a biasing circuit, and a plurality of multi-color lights that change color. An article has a recess for receiving the lighting module. The controller controls different lamps disposed in regions of the lighting module based on movement or other external factor or force detected by the sensor. The regions include indicia that provide changing facial expressions by operating different lamps when detection of motion occurs repeatedly within predetermined time periods.

### RELATED APPLICATIONS

This application claims priority from and the benefit of U.S. provisional application 62/013,879, filed Jun. 18, 2014, and U.S. provisional application 62/081,382, filed Nov. 18, 2014, the entire contents of which are both hereby incorporated by reference.

### BACKGROUND

The embodiments described herein relate to lighting systems activated by motion or manually with changing colors and/or light patterns. More particularly, the discloses embodiments relate to decorative illumination arrangements and features for a variety of articles, including toys, wearable articles, bedding, novelty articles, and drinking glasses with or without a figurine. The disclosed embodiments also relate to lighting modules provided with an article that are activated by motion, manually or otherwise in a predetermined manner for changing an image by selectively illuminating indicia in a variety of patterns.

### SUMMARY

In one embodiment, the invention provides a modular lighting system including a plurality of wearable articles or other types of articles, such as a variety of different types of toys (including plush and other types of figures) and novelty items, that can be selectively manipulated by a person (hereinafter all collectively referred to for convenience as “a wearable article”), and a light module that is designed to be removable from the wearable articles. The light module includes a lighting circuit and a housing that encloses the lighting circuit. The lighting circuit includes a plurality of RGB LEDs, a battery, a motion switch, an electronic switch, and a biasing circuit. The biasing circuit provides a proper voltage to bias the electronic switch and to drive the RGB LEDs. The RGB LEDs change colors according to internal components that cycle the RGB LEDs through each color according to a predetermined timing

In one embodiment, the invention provides a light emitting system for articles comprising: a light emitting module having a housing, the housing enclosing a lighting circuit, the lighting circuit including a mode selecting switch providing an input to a controller, the controller providing outputs to selectively power at least one light emitting device connected thereto, wherein a first mode comprises output of a single color and a second mode comprises at least one of changing color and/or flashing of the at least one light emitting device.

In another embodiment of the invention the light emitting module has a generally cylindrical disc shape and the mode selecting switch comprises a push button switch disposed on one side the light emitting module.

In another embodiment the light emitting system comprises a toy with foot or support elements, and the light emitting module is disposed adjacent one of the foot or support elements, and the light emitting module is oriented for ease of actuation by a user grasping the toy. In one embodiment, the toy includes an essentially transparent inflatable object received within an exterior fabric, the fabric including the foot or support elements.

In one embodiment, the light emitting module comprises a rim for receiving the bottom of a drinking glass to form an integral unit. In one embodiment the rim comprises a compressible material for receiving and urging against a lower outer edge of the drinking glass. In another embodiment, the rim includes threads thereabout to secure with threads provided on a lower outer edge of the glass.

In another embodiment, a drinking glass includes an aperture or dome at a lower end thereof that receives a figurine. In some embodiments, the at least one light emitting device comprises a plurality of light emitting diodes.

In one embodiment, the invention provides a lighting module for wearable articles or other types of articles that can be selectively manipulated by a person (hereinafter collectively referred to for convenience as “a wearable article”). The light module is designed to be removable from the wearable articles and to provide light in response to movement of a wearer or other manipulation by a user. The lighting module includes a housing, the housing enclosing a lighting circuit, the lighting circuit including a power supply, a motion sensor and/or switch, a controller, a lamp panel and a plurality of lights connected to the lamp panel, wherein the housing includes first and second spaced regions having a shape and each of the first and the second spaced regions having a light to provide a display, and wherein the housing includes a third region that includes at least three lights, each of the lights being associated with one of first indicia, second indicia and third indicia in the third region. The motion sensor and/or switch is configured to provide a signal to the controller in response to motion or manipulation of the switch, and the controller provides an output to the lamp panel to selectively control the lights in response to the signal, the controller providing an output to power one of the at least three lights in the third region to display one of the first indicia, the second indicia and the third indicia.

In some embodiments, indicia provided for the first and the second regions of the lighting module comprises eye indicia, and the lights of the first and the second regions provide illumination to flash light that is output about eye indicia. In some embodiments, the indicia in the third region provides first, second and third expressions for a character corresponding to the three indicia in the third region, each of the indicia corresponding to at least one of the lights, wherein the lights are selectively operated to illuminate the corresponding indicia.

In some embodiments, a first one of the lights in the third region of the lighting module is actuated in response to motion detection by the motion detector, wherein a second detection by the motion detector within a predetermined time operates a second one of the lights and deactivates the first one of the lights, and wherein a third detection by the motion detector within a predetermined time after the second detection activates the third one of the lights in the third region and deactivates the second one of the lights. In another embodiment, the first light, the second light, and the third light each illuminate different indicia corresponding to three different expressions.

In another embodiment, the invention is a wearable foot article with a lighting module comprising: a sole, a foot article body and a front top member including a recess, the recess located near the foot opening of the foot article for receiving a foot of a wearer and extending toward a front of the foot article, the front top member including at least first, second and third openings. The embodiment includes at least one light module having a housing, the housing configured to fit within the recess and enclosing a lighting circuit, the lighting circuit including a power supply, a motion sensor, a controller, a lamp panel and a plurality of lights connected to the lamp panel. In one embodiment, the housing includes first and second spaced regions having an elliptical shape and each of the regions having at least one of the lights to provide a display, and the housing includes a third region provided with indicia and that includes at least three lights for providing a display.

In one embodiment, the first and second spaced regions of the housing of the lighting module are in alignment with the first and second openings of the front top member, and the third region is in alignment with the third opening during use, wherein the plurality of lights project light from the foot article through the openings.

In another embodiment, a lighting module for articles comprises a lighting module having a housing, the housing enclosing a lighting circuit, the lighting circuit including a power supply, a sensor responsive to manipulation by a user, a controller, a lamp panel and a plurality of lights connected to the lamp panel, wherein the housing includes a first region having a shape and at least one light to provide a display, and wherein the housing includes a second region that includes at least two lights, each of the two lights being associated with one of first indicia and second indicia in the second region to provide a display. In the embodiment, the sensor is configured to provide a sensor signal to the controller, and the controller provides an output to the lamp panel to selectively control the lights in response to the sensor signal, the controller providing an output to power one of the at least two lights in the second region to display one of the first indicia and the second indicia. In another embodiment, the second region has a mouth shape and the first indicia and the second indicia of the second region each correspond to a facial expression of a mouth.

In another embodiment, a display unit comprises a housing, the housing enclosing a lighting circuit, the lighting circuit including a power supply, a sensor responsive to manipulation by a user, a controller, and at least two lights, and a display provided on the housing, the display comprising at least first indicia and second indicia to provide an image, wherein the sensor is configured to provide a sensor signal to the controller, and the controller provides an output to selectively control the lights in response to the sensor signal, the controller providing an output to power at least one of the at least two lights to display at least one of the first indicia and the second indicia.

In another embodiment, the image comprises a character, and the at least first and second indicia comprise three indicia for providing first and second expressions for the character, wherein the controller selectively activates the lights to illuminate the three indicia to alternate between the first and second expressions. In one embodiment, the character comprises an emoticon and the display unit comprises an emoticon unit, and the expressions comprise a smiling image and a frowning image.

In one embodiment, the display unit includes a clip for securement to an article or a mounting element with apertures for securement to an article.

Other aspects of the invention will become apparent by consideration of the detailed description and accompanying drawings.

### BRIEF DESCRIPTION OF THE DRAWINGS

FIG. 1 illustrates a modular lighting system.

FIG. 2 illustrates a recess in a wearable article.

FIG. 3 illustrates a lighting circuit in a housing.

FIG. 4 is a schematic of the lighting circuit.

FIG. 5 illustrates the change of color of each of the lighting elements.

FIG. 6 illustrates a process for lighting the lighting elements.

FIG. 7 illustrates a slipper with a plush character or a light transmissible window.

FIG. 8 illustrates a slipper with a plush character and a recess for the light module.

FIG. 9 illustrates different shoes that can also include the recess for the light module.

FIG. 10 illustrates a hat as a wearable article.

FIG. 11 illustrates gloves as a wearable article.

FIG. 12 illustrates a bag as a wearable article.

FIG. 13 illustrates a jacket as a wearable article.

FIG. 14 illustrates a front view of a plush toy corresponding to one embodiment of the invention.

FIG. 15A illustrates a perspective view of a base side of a light emitting module.

FIG. 15B illustrates a perspective view of a base side of a light emitting module with a cover removed.

FIG. 16 illustrates a perspective view of a light emitting side of the light emitting module.

FIG. 17 illustrates a perspective cross-sectional view taken at I-I of FIG. 16.

FIG. 18 illustrates a perspective cross-sectional view taken at I-I of FIG. 16.

FIG. 19 illustrates a schematic circuit for the light emitting module.

FIG. 20 illustrates a perspective view of drinking glass and a light emitting module.

FIG. 21 illustrates another perspective view of the drinking glass and the light emitting module.

FIG. 22 illustrates a schematic circuit for the light emitting module.

FIG. 23 illustrates a perspective view of a drinking glass, figurine and light emitting module.

FIG. 24 illustrates a perspective view of a light emitting module and an article receiver.

FIG. 25 illustrates a top view of the light emitting module and the article receiver shown in FIG. 24.

FIG. 26 illustrates a wearable article including a lighting module.

FIG. 27 illustrates a recess in a wearable article.

FIG. 28 illustrates a lighting module.

FIG. 29 illustrates another wearable article including a lighting module

FIG. 30 is a schematic of the lighting circuit.

FIG. 31 illustrates a routine for operating the lighting module.

FIG. 32 illustrates a sandal, a tennis shoe and a casual shoe including a lighting module.

FIG. 33 illustrates a hat including a lighting module.

FIG. 34 illustrates a glove including a lighting module.

FIG. 35 illustrates a bag including a lighting module.

FIG. 36 illustrates a jacket including a lighting module.

FIG. 37 is a schematic of a lighting circuit.

FIG. 38 is a front view of a display unit.

FIG. 39 is a rear view of a display unit.

FIG. 40 is a perspective view of a display unit with a mounting element secured to a shoe.

FIG. 41 is a rear view of a display unit with a clip.

FIG. 42 is a perspective view of bedding including a lighting arrangement.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

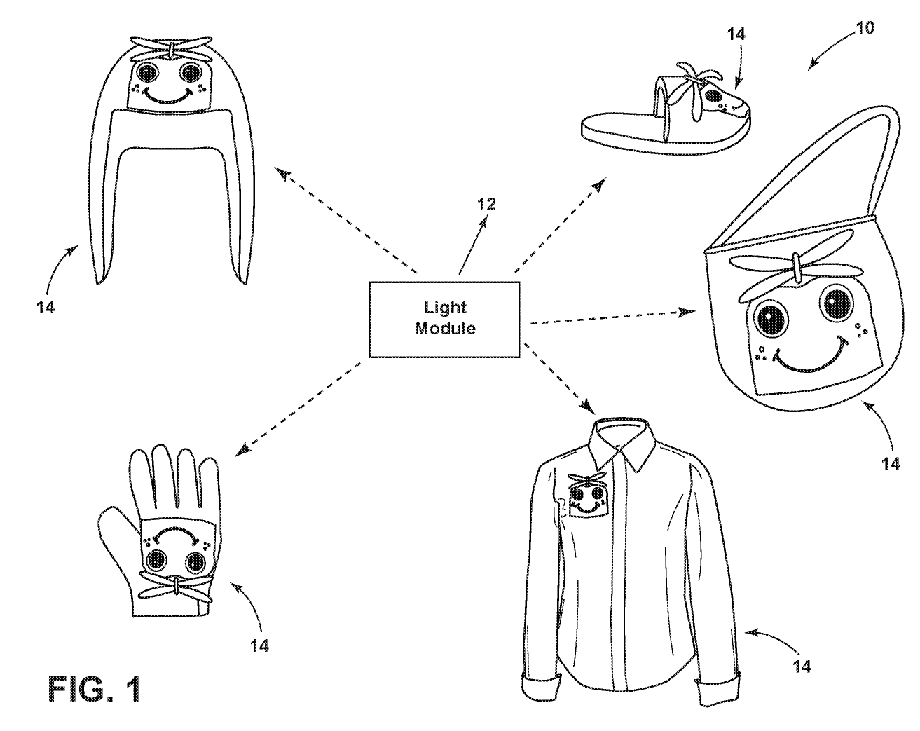

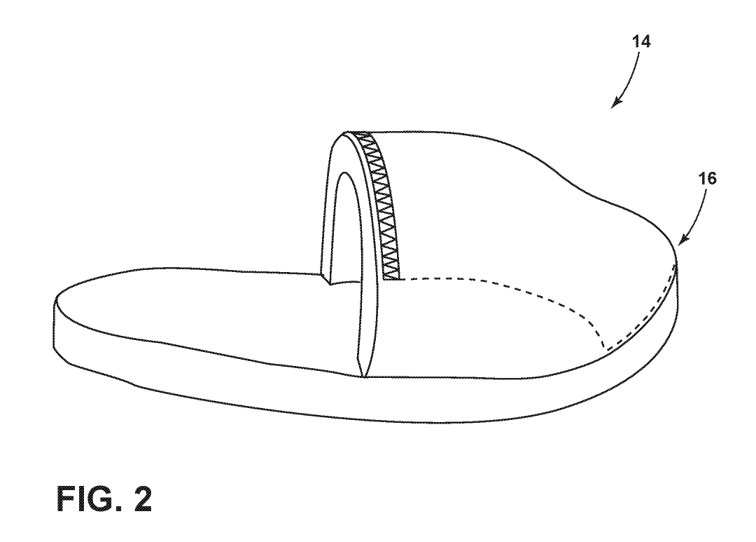

FIG. 1 illustrates a modular lighting system 10 including a light module 12 and a plurality of wearable articles 14. Each of the wearable articles 14 includes a recess or other type of suitable enclosure or compartment (hereinafter collectively referred to for convenience as a “recess”), as shown in FIG. 2, to receive the light module 12.

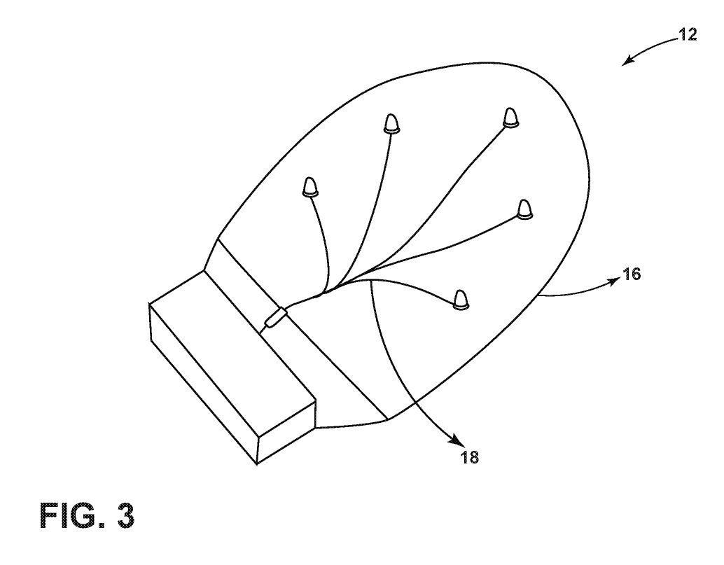

FIG. 3 illustrates the light module 12 including a housing 16 and a lighting circuit 18. The housing 16 may be made of different materials. In one embodiment the housing 16 is made from flexible, durable, and transparent material that is compatible with specific wearable articles 14. For example, the housing 16 made from flexible material can be used with slippers or hats. In a different embodiment the housing 16 is made from a rigid and transparent material that is compatible with a different set of wearable articles 14. For example, the housing made from rigid material can be used with a water bottle.

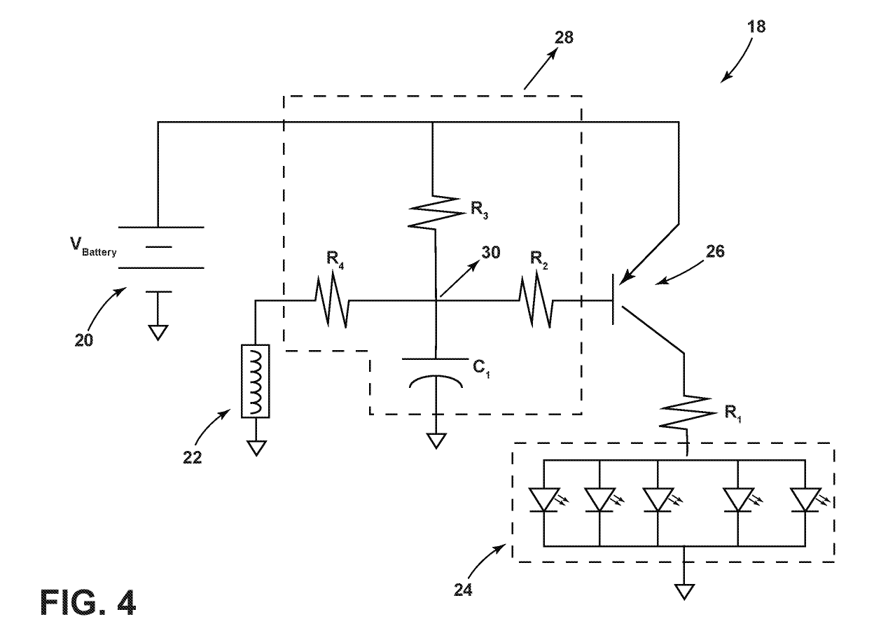

The lighting circuit 18, as shown in FIG. 4, includes a battery 20, a motion switch 22, a plurality of lighting elements 24, an electronic switch 26, and a biasing circuit 28. The motion switch 22 detects motion in the wearable article 14 and starts the activation of the lighting elements 24. When the motion switch 22 closes, the biasing circuit 28 appropriately biases the electronic switch 26. In the embodiment shown, the electronic switch 26 is a bipolar junction transistor (BJT) including a base node, an emitter node, and a collector node. The electronic switch 26 then drives the lighting elements 24.

Rather than using a microprocessor, discrete components are connected in a particular manner to properly control the lighting elements 24. For example, as shown in FIG. 4, the biasing circuit 28 includes three resistors, R2, R3, and R4. R3 is electrically connected to the positive end of the battery 20, and to a common node 30 between R2, R4, and a capacitor C1. R4 is electrically connected to the motion switch 22 and to the common node 30. The motion switch 22 is only connected to R4 and to ground. The capacitor C1 is connected between the common node 30 and ground. R2 is connected to the common node 30 and to the base node of the BJT. The emitter node of the BJT is connected to the positive end of the battery 20 and to R3, while the collector node of the BJT is electrically connected to a current limiting resistor R1 and the plurality of lighting elements 24. The lighting elements 24 are connected in parallel. When the motion switch 22 closes, the biasing circuit 28 forms a resistor network that delivers more than a minimum emitter-base voltage to the base node of the BJT to cause the BJT to operate in a forward-active mode. When sufficient voltage is applied to the base node of the BJT (e.g., when the BJT is in a forward-active mode), an emitter current flows through the BJT and increases the collector current. The collector current provides energy for the lighting elements 24 to light up.

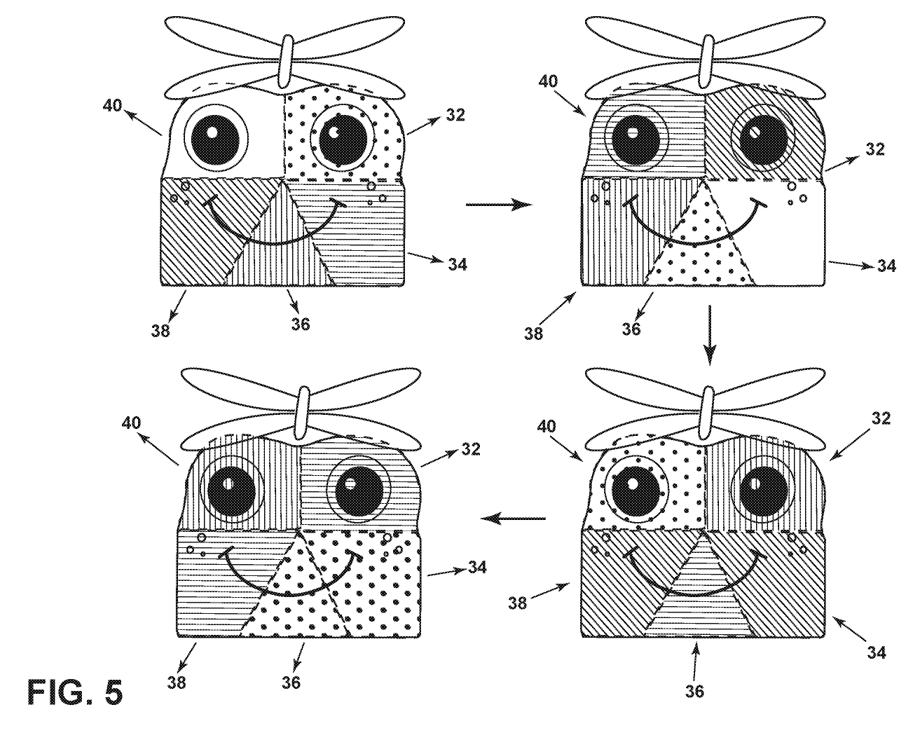

The lighting elements 24 include multi-color lights. In the particular embodiment shown, the lights are color-changing LEDs. Each lighting element 24 is an RGB or similar LED with internal components that change the output color. For example, an RGB LED will cycle through each color according to a predetermined timing (e.g., two seconds per color). The lighting circuit 18 includes a plurality of lighting elements 24. When all of the lighting elements 24 are activated (i.e., when the motion switch 22 is activated), each lighting element 24 begins lighting up in changing colors in a seemingly random order. Differences in distance and resistance between the emitter node of the BJT and each lighting element 24 cause each LED to be activated at a different time. As a consequence, the lighting sequences are not synchronized. This adds to the random appearance of the lighting. FIG. 5 illustrates the progression of the lighting process in a slipper. Each section in FIG. 5 represents an area being illuminated by a single lighting element 24. In the example shown in FIG. 5, Section 32 starts in red (as shown by the dotted shading), section 34 starts in green (as shown by the horizontal line shading), section 36 starts in blue (as shown by the diagonal line shading), section 38 starts in pink (as shown by the vertical line shading) and section 38 starts in yellow (as shown by the unshaded area). At a later time (for example two seconds), the sections each change colors. At any time, each lighting element 24 might be a different color, or a repeated color, as shown in FIG. 5. The lighting elements 24 continue to light up and change colors until the motion switch 22 stops being activated or moved. Once the motion switch 22 stops detecting motion or motion drops below a certain threshold, the lighting elements 24 will continue to light up in changing colors for a predetermined amount of time, for example six seconds, after which the lighting elements will turn off.

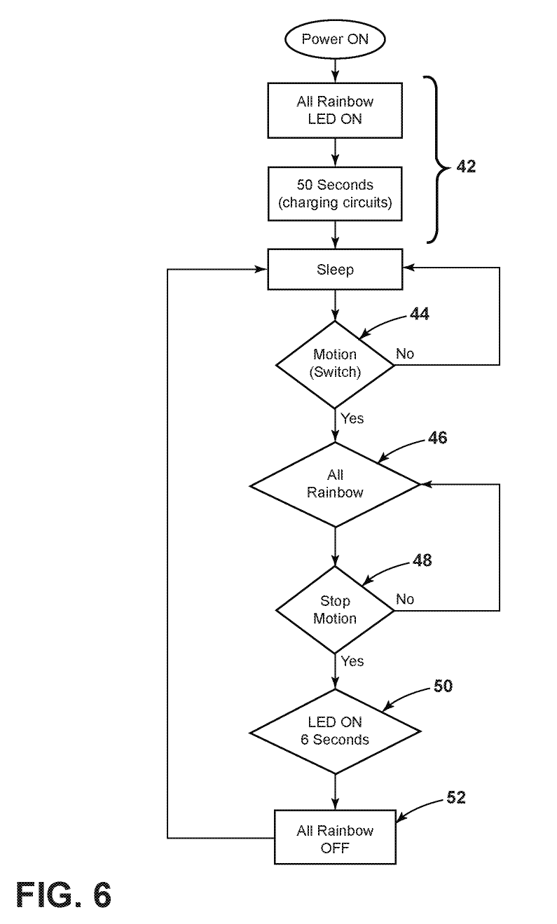

FIG. 6 illustrates a flowchart that graphically represents the operation of the lighting circuit 18. At first, when the battery 20 is placed in the circuit (in the embodiment shown there is no on/off switch, although one could be provided), the lighting elements 24 turn on after the capacitor C1 has charged (block 42). If the motion switch 22 is activated (or, more particularly, closed) by motion (block 44), then the lighting elements 24 light up in changing colors (block 46). The lighting elements 24 will continue to light up and change colors (block 46) so long a motion occurs. Once motion has stopped (block 48), the lighting elements 24 will remain lit for predetermined amount of time (in one embodiment, about 6 seconds) (block 50), and then turn off (block 52) until the next time the motion switch 22 is activated.

As shown in FIG. 2, the light module 18 can be received within the recess 16 in a wearable article 14. Once inside the recess 16, the lighting elements 24 can be activated by the motion of the wearable article 14 caused by movement of the wearer. As soon as motion is detected by the motion switch 22 (or causes the motion switch to close), the lighting circuit is activated and the wearable article 14 begins to light up in changing colors. Once the light module 12 has been inserted into the recess 16, the light module 12 can easily be removed either to light up a different wearable article 14 or to wash the previously used wearable article 14. Since the light module 12 is easily inserted and removed from the recess 16 in the wearable article 14, the modular lighting system 10 provides flexibility to the user in a number of ways. For example, the lighting module may be moved from one wearable article to another, different lighting modules may be substituted in a wearable article, multiple modules may be used at the same time using multiple recesses, a recesses designed to hold two or more modules may be used, and multiple wearable articles, each with one or more recesses, may be worn. Of course a module may be removed from a recess and once outside the wearable article 14, the battery 20 of the light module 12 can be easily changed when needed.

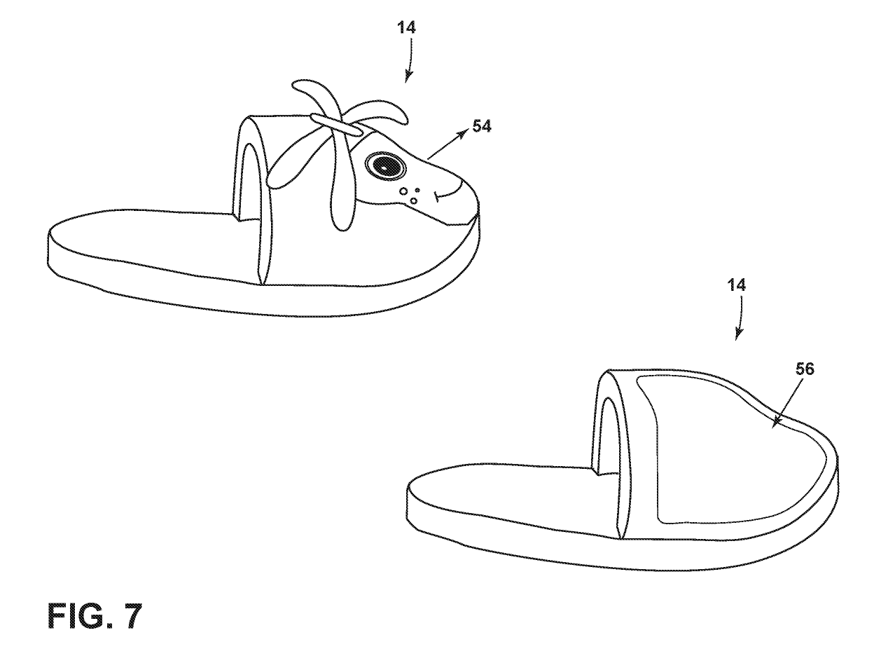

In some embodiments the wearable article 14 includes a light transmissible character 54 for displaying the changing colors of the light module 12, as shown in FIG. 7. In other embodiments, the wearable article 14 includes a light transmissible window 56 for displaying the changing colors of the light module 12, as shown also in FIG. 7. The light transmissible window 56 can be made from an opaque color so that the internal electronic components of the light module 12 are not visible, and only the changing colors can be perceived by the user. Each of the embodiments described below can be easily configured to include the character 54 or the window 56.

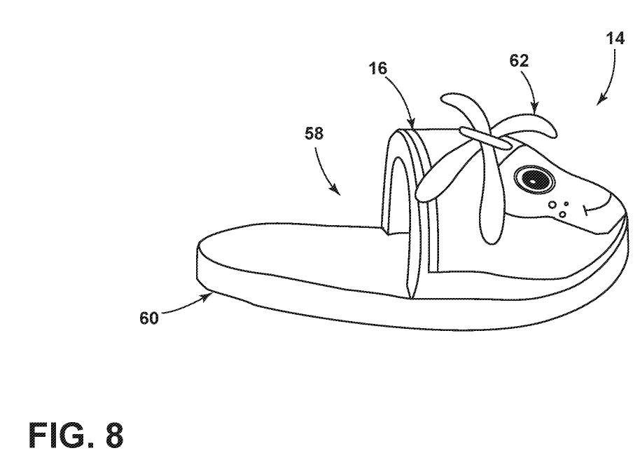

FIG. 8 illustrates an embodiment of the wearable article 14. In this embodiment, the wearable article 14 includes a slipper 58. The slipper 58 includes a sole 60 and a character 62. The light module 12 is inserted into the recess 16 behind the character 62. The lighting circuit 18 is activated with each step a user takes with the slipper 58. The character 62 can be any recognizable character such as an animal, or it can be an easily recognizable cartoon, super hero, politician, or other fanciful or real character or image. The character 62 transmits the light from the lighting circuit 18 and will appear to light up in randomly changing colors or patterns with each step of the user.

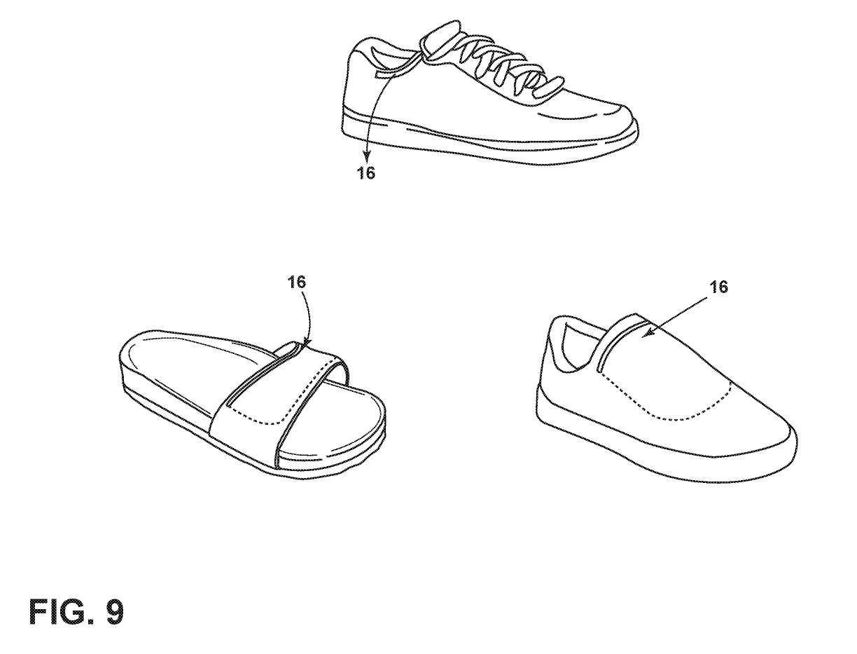

The wearable article 14 can also include other types of shoes, as shown in FIG. 9. FIG. 9 illustrates other popular types of footwear. A recess, like recess 16 in FIG. 8, can be provided in many types of articles of clothing or other articles, such as toys, without deviating from the scope of the application. FIG. 9 illustrates a recess 16 in a sandal, a tennis shoe, and a casual shoe.

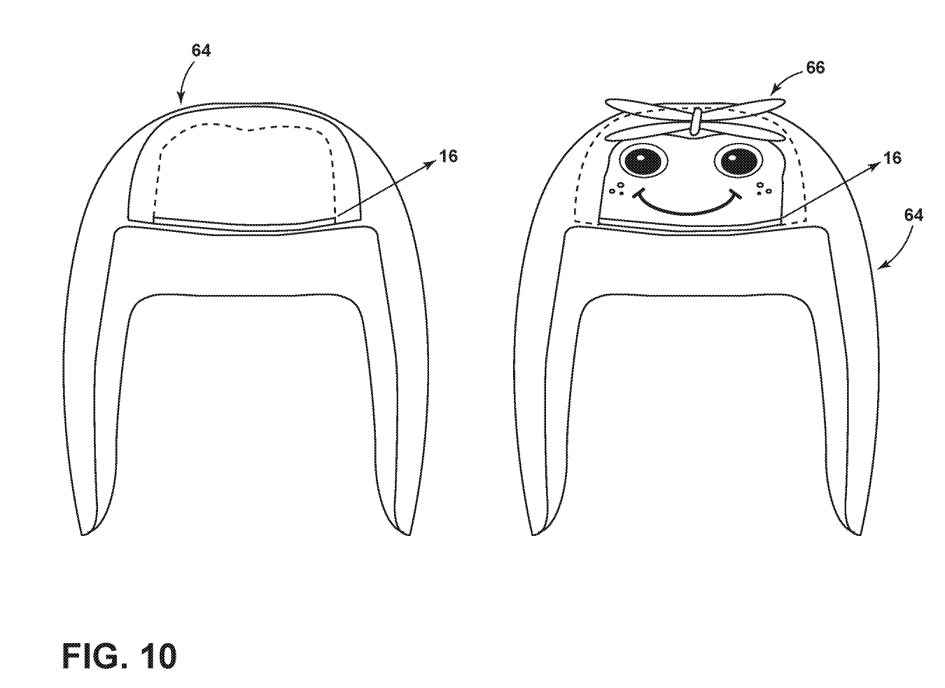

FIG. 10 illustrates a different embodiment for the wearable article 14. The wearable article in this embodiment includes a hat 64. The hat includes a recess 16 to receive the light module 12. Optionally, the hat may include a character 66 that displays the changing colors of the light module 12.

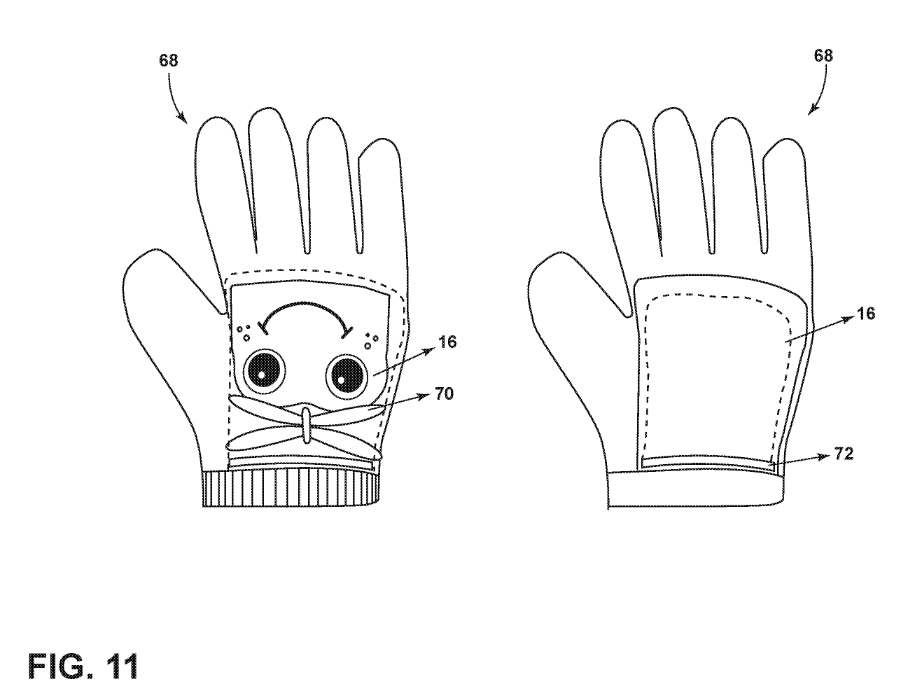

In a different embodiment, as shown in FIG. 11, the wearable article 14 includes a pair of gloves 68. The gloves 68 include a recess 16 to receive the light module 12 and either a light transmissible character 70 or a light transmissible window 72.

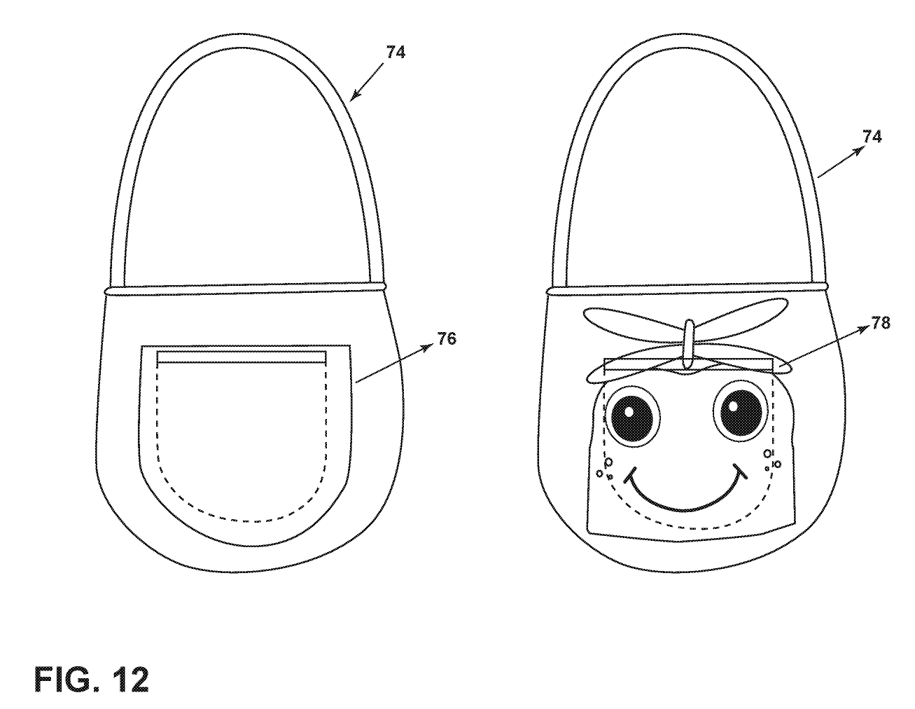

FIG. 12 illustrates a different embodiment in which the wearable article 14 includes a bag 74 with a recess 16 to receive the light module 12. The bag 74 may include a light transmissible window 76 for displaying the changing colors, or it may include a light transmissible character 78.

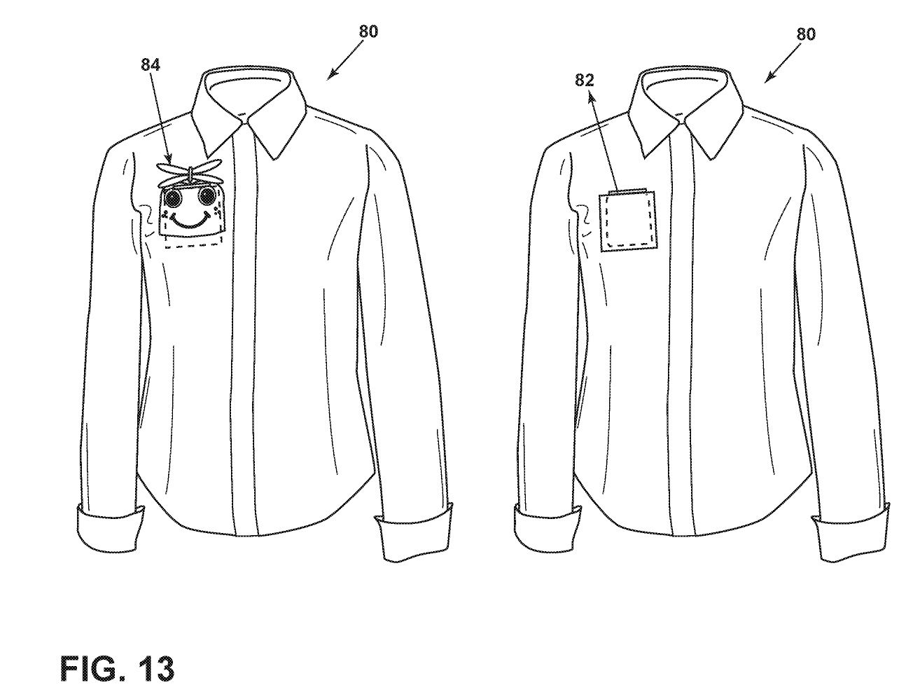

FIG. 13 illustrates a different embodiment in which the wearable article 14 includes a jacket 80 with a recess 16 to receive the light module 12. The jacket 80 may include a light transmissible window 82, or it may include a light transmissible character 84.

Thus, the invention provides, among other things, a multi-color modular lighting system that allows for different wearable articles or other types of articles that can be selectively manipulated by a person to be lit up with a single light module.

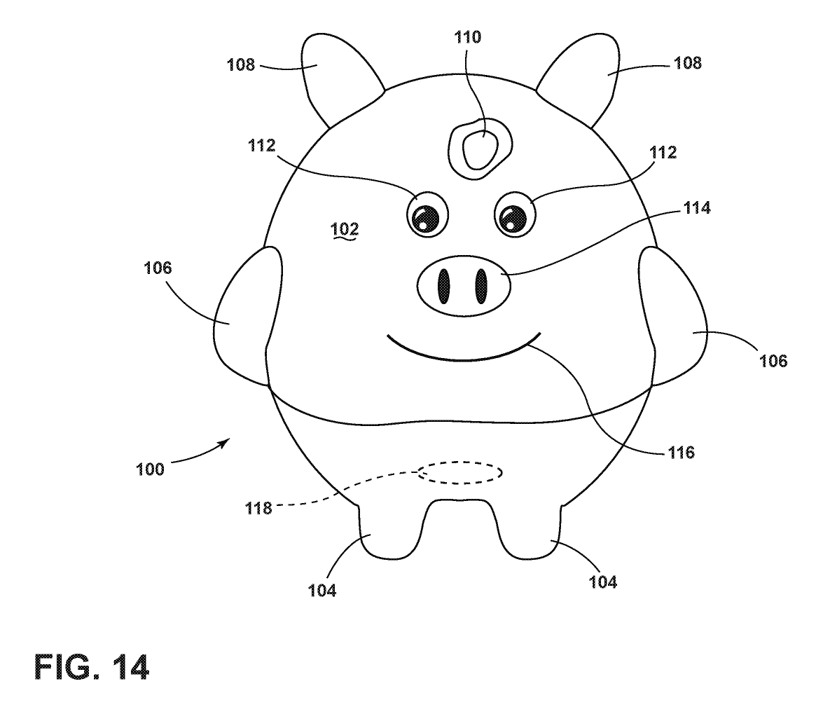

FIG. 14 shows an embodiment of a plush toy 100. The toy 100 includes a transparent or translucent inflatable object (not shown), such as an inflatable ball or other type of compartment having an air valve. A skin 102 for forming the outer cover of toy 100 may be a light or plush fabric or other material that permits a significant amount of light to pass therethrough. In assembly, the inflatable object is placed within the skin 102 and enclosed within by Velcro, a zipper or other means. Then, the object is inflated to obtain the toy 100 shown in FIG. 1.

Embodiments of the toy 100 may include appendages such as paws, support elements or foot elements 104 as shown in FIG. 14. Further, the toy 100 may include hand-type members 106, ears 108, and optionally a forehead member 110. Embodiments may also include faces defined by eyes 112, a nose 114 and a mouth 116, or other features to represent different types of animation, fanciful characters, and other objects.

In one embodiment, one of the support or foot elements or paws 104 of the toy 100 shown in FIG. 14 includes a receiving area (not shown) for receiving an external push button switch (not shown) that is connected by wires to a light emitting module disposed within the toy. In this embodiment, the toy 100 is not washable.

In another embodiment illustrated in FIG. 14, the light emitting module 120 is disposed between the inflatable object (not shown) and the plush skin 102 as shown by a pocket 118 at a location at the base of the toy 100. The pocket 118 may include a zipper or Velcro to secure an opening that enables access to replace the light emitting module 120. The toy 100 or other article, and the light emitting module 120, form a light emitting system to emit light upwardly and outwardly through the inflatable object and through the skin 102 of the toy In the FIG. 14 embodiment, the light emitting module 120 is removable to permit washing of the toy 100.

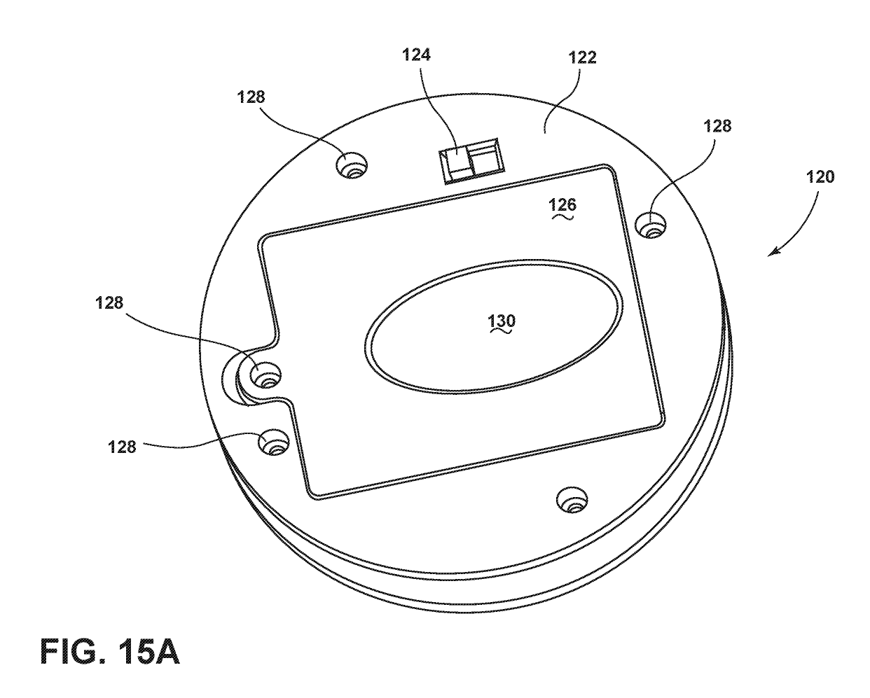

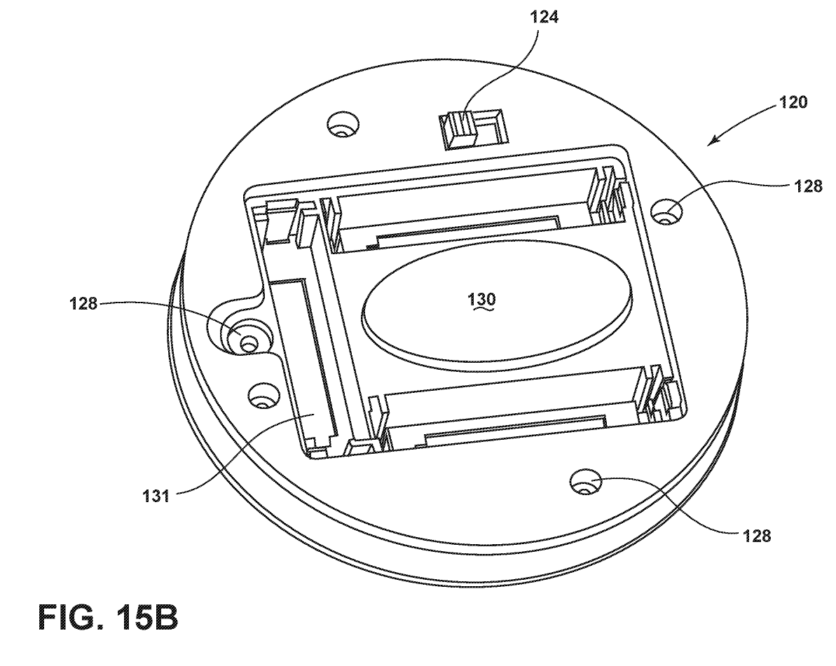

The light emitting module 120 illustrated in FIG. 15A is formed by a module base 122 that has an ON/OFF switch 124. Further, the light emitting module 120 includes a battery cover 126 for a chamber that, for example, receives batteries to power the light emitting module. Apertures 128 receive fasteners to secure various elements, such as the module base 122 and the battery cover 126 to form the light emitting module 120. Further, FIG. 15A illustrates a push button switch 130, such as a spring contact switch, for the light emitting module 120. The light emitting module 120 is oriented so that upon pushing the push button switch 130, light is projected into and through the inflated object to different areas of the plush skin 102 for output therefrom.

FIG. 15B illustrates the light emitting module 120 with the battery cover 126 removed. Battery compartments 131 are provided for receiving batteries to power the light emitting module 120.

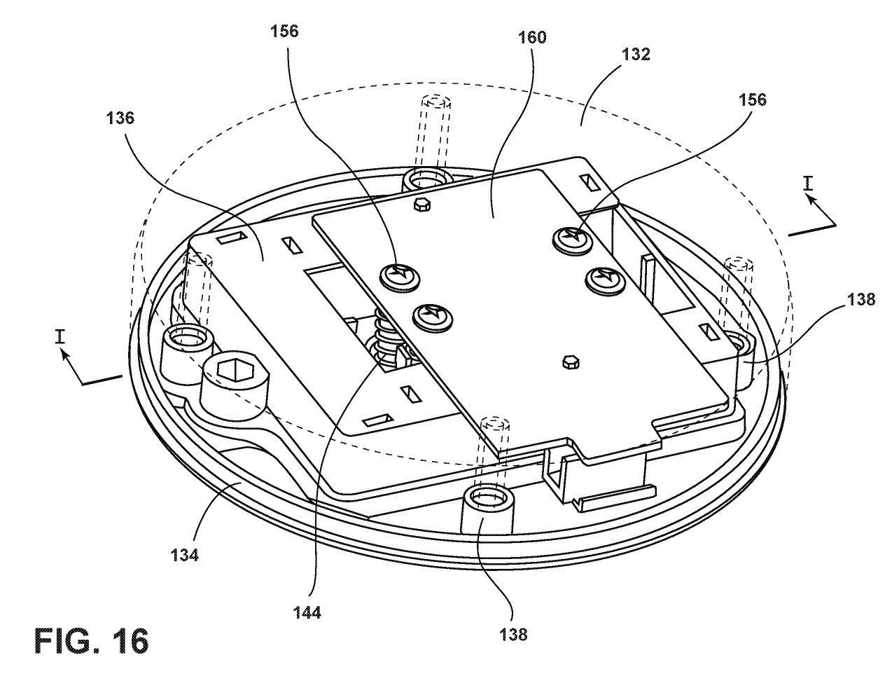

FIG. 16 shows a perspective view of the light emitting module 120. The module base includes a module base rim 134 and a module support body 136. Module support apertures 138 are formed in projections extending inwardly from an inner face of the module base 122. A transparent or translucent cover 132 extends about and is supported on the module base rim 134. The cover defines a top portion of the light emitting module 120. The module base 122 and the cover 132 form a housing of the light emitting module 120. The light emitting module 120 is formed with a generally cylindrical disc shape.

When the light emitting module 120 is inserted into or disposed within the plush toy 100 at location 118 shown in FIG. 14, the push button switch 130 is oriented downwardly and the transparent cover 132 is oriented upwardly toward the transparent inflatable object. The orientation enables light transmission through the inflatable object and outwardly via the fabric forming a skin 102 of the toy.

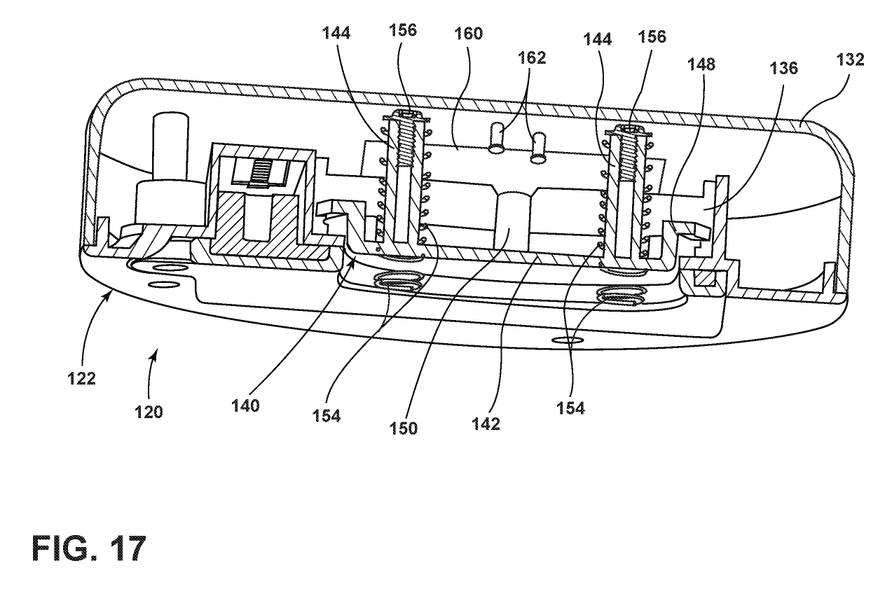

The cross sectional view of FIG. 17, which is taken from FIG. 16, shows a switch assembly 140 that is assembled within the module base 122. The switch assembly 140 includes a switch base 142, switch mount posts 144, an annular flange 148, and a central post 150. Further, the switch assembly 140 includes springs 154 that are biased against the push button switch 130 shown in FIG. 15 and circuit board fasteners 156.

FIG. 17 shows the circuit board fasteners 156 securing a circuit board 160 to the switch assembly 140. The circuit board 160 includes light emitting diodes (LEDs) 162 mounted thereon. Other circuitry described below is also secured to the circuit board 160 and not shown.

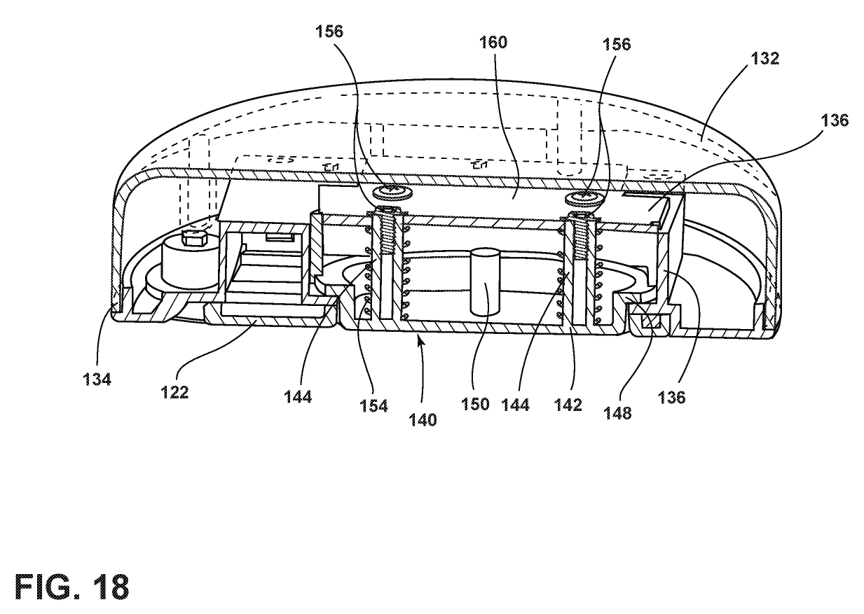

FIG. 18 is a cross sectional view also taken from FIG. 16. FIG. 18 shows the circuit board 160 provided on the central post 150. Again, circuit board fasteners 156 secure the circuit board 160 to the module support body 136, indirectly or otherwise.

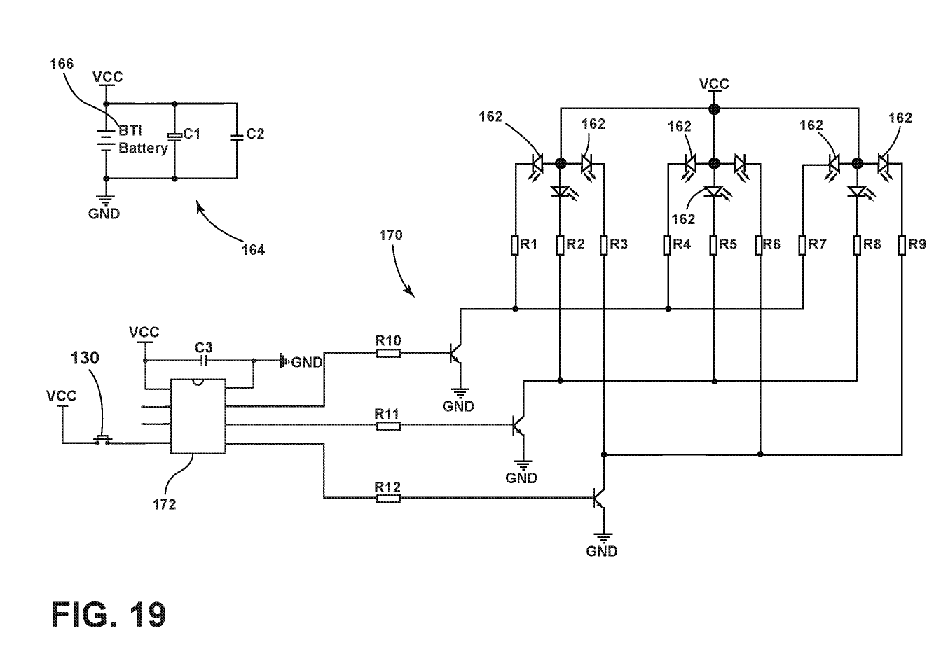

FIG. 19 shows a schematic of a power supply circuit 164 having at least one battery 166 to provide a voltage VCC. The battery 166 represents a pair of batteries disposed within the light emitting module 120 by removing the battery cover 126. Capacitors C1, C2 are connected across the battery 166.

FIG. 19 also shows a schematic of a lighting circuit 170. The lighting circuit 170 includes the push button switch 130 providing an input to a controller 172. The controller 172 receives the voltage VCC at input VDD thereof. Further, the controller includes internal counters and timers. The controller 172 provides outputs PA0, PA1, PA2 to respective transistors. In the embodiment shown in FIG. 19, the lighting circuit 170 includes three sets of red, green, blue light emitting diodes 162. Each transistor connects to the same color in each of the sets of LEDs 162. For example, one transistor connects to red diodes, a second transistor to green diodes and a third transistor to blue diodes. Resistors 4 are provided to control current and voltage in the lighting circuit 170.

Operation

In a first step, the ON/OFF switch 124 on the light emitting module 120 is moved from an OFF position, wherein no power is supplied by the battery 166 to any device and an ON position, wherein power VCC is supplied to the push button switch 130, the controller 172 and the LEDs 162. Then, push button switch 130 of the light emitting module 120 disposed at a lower end of the toy 100 is actuated by a user applying downward force, for example, to the head or top area of the toy that traverses through the inflatable object to close the push button switch and begin operation of the lighting circuit 170.

For example, in one embodiment, the lighting circuit 170 operates in three modes that are sequenced by the actuation of the push button switch 130. When the push button switch 130 is actuated a first time, white light is output by LEDs 162. More specifically, each of the three transistors is biased on by outputs from PA0, PA1, PA2 of the controller 172. Thus, each of the LEDs 162 receives power and outputs light. In one embodiment, each set of LEDs 162 is one each of RED, GREEN and BLUE. Thus, the combined light of the different colored LEDs provides an intense white light that is viewable through the skin 102 of the toy. In one embodiment, the white light is constant, although flashing light is contemplated.

Two actuations of the push button switch 130 advances the controller 172 to a second mode. The second mode is a light show performed by the lighting circuit 170, which may comprise random or predetermined patterns of various flashing LEDs. More specifically, in the second mode, various LEDs are flashed at various rates. For example, only RED LEDs are flashed via the appropriate transistor for a predetermined time. Then a new color can be provided by one or more LEDs for each set. Different flash rates are contemplated. In some embodiments the time the light is illuminated is much greater than the time that the light is extinguished. For example, light is output at a high duty cycle. In some embodiments, the light show is a stored pattern. In other embodiments, random generation of a light pattern is contemplated for the controller 172.

In either of the two modes discussed above, a predetermined time period after the most recent actuation of the push button switch 130 is completed, the controller 172 ends the output of light by the LEDs 162. In one embodiment, the predetermined time period is between about 7 minutes and about 15 minutes. In another embodiment, the predetermined time period is about 10 minutes.

When the lighting circuit 170 is operating in the second mode, another actuation of the push button switch 130 stops operation of the LEDs 162. The lighting circuit 170, however, remains in an on state. Power is supplied to the controller 172, which waits for an input from the push button switch 130. The separate ON/OFF switch 124 prevents power from the battery 166 to the controller 172 and prevents output of battery power entirely.

The toy 100 shown in FIG. 14 is one exemplary embodiment of an article that can be illuminated as described above and which provides a pleasing toy animal or character appearance or other type of image in combination with selectable and aesthetically pleasing lighting arrangements. In one embodiment, the toy 100 has a generally rectangular shape, while maintaining a pleasing toy animal appearance or the like. In another embodiment, the toy 100 has a generally round shape. In some embodiments, the rectangular and ball or rounded shaped toys are a plush type of material and include a light emitting module 120 having a push button switch 130 and a mounting arrangement wherein the push button switch 130 is actuated by touching the toy. Other embodiments are contemplated, including different lighting patterns and effects.

In another embodiment, the article is a toy animal or other character in appearance. Instead of having an inflatable object, this embodiment relies on an expanded polypropylene (EPE) foam (not shown). The EPE foam is resistant to moisture absorption and provides some flexibility. In one embodiment, the EPE foam is shaped in a similar manner as the skin 102 of the toy 100. Thus, the EPE foam is inserted into the skin, along with the light emitting module 120. The light emitting module 120 is inserted into or disposed within the article at location 118 shown in FIG. 14. The push button switch 130 is oriented downwardly and the transparent cover 132 is oriented upwardly toward the EPE foam. The orientation enables light transmission through the EPE foam and outwardly via a translucent or transparent fabric or other type of material through which light can be transmitted forming a skin or outer cover 102 of the toy 100. In one embodiment, the EPE foam is a monolithic element shaped to fit in surface to surface contact with the skin 102. In another embodiment, the EPE foam is a plurality of elements disposed within the skin 102 that support LEDs to provide illumination with different lighting patterns and effects provided by the schematic circuit shown in FIG. 19. While EPE foam is one material with suitable properties, other materials, including foams having similar properties are contemplated. For instance, the EPE foam with LEDs is compressible and yet rigid enough so that the switch can be actuated by pushing the top or head of the toy 100. The toy 100 operates in essentially the same manner as the inflatable toy described above.

In another embodiment, the exterior of the toy 100 is treated with an ultraviolet light reactive material, typically in the form of a spray. The spray can include rare earth chemicals that become excited and produce visible when illuminated with ultraviolet light. Different rare earth chemicals may produce different colors of light. The effect is generally known as one or more of luminescence, fluorescence or phosphorescence. An ultraviolet light pen is provided for reacting with the spray that has been coated on the toy 100 to provide drawing designs, words and pictures on the toy. In darkness, the designs are viewable on the toy 100 for a given period of time. By operating the LEDs in the toy 100, a user may erase the design and begin providing a new design. In one embodiment, stencils are provided to assist in creating designs.

Another embodiment includes a backpack. The backpack has straps and one or more sections for placing articles. The backpack includes an extra pocket on the upper front portion, whereat the light emitting module 120 is placed. The light emitting module may directly emit light through a fabric or cover and rearwardly from the backpack. In another embodiment, the pocket is relatively thin and may extend a large portion of the length of the backpack. An inflatable object is placed in the pocket with the light emitting module. The inflatable object is also relatively thin and allows light to travel along the length thereof. In another embodiment, the inflatable object is replaced with a foam material as discussed above. Regardless, the material that is the skin, cover or outer layer of the backpack allows light to pass through and project outwardly and rearward therefrom. The extra pocket includes a Velcro or other fastener to maintain the position of the light emitting module 120 relative to the backpack. Thus, the light emitting module 120 is located at the top of the backpack so that a user may press the push button thereof directly through an outer layer of exterior fabric or skin of the backpack. Other locations for the push button are contemplated. LEDs are located to project light outwardly and rearwardly from the inflatable object for a user with the backpack placed on their back and with the straps on respective shoulders. This embodiment utilizes light emitting module 120 and the schematic circuit shown in FIG. 19 to selectively provide pleasing light effects. The light effects result in the user of the backpack being more visible to others.

Drinking Glass

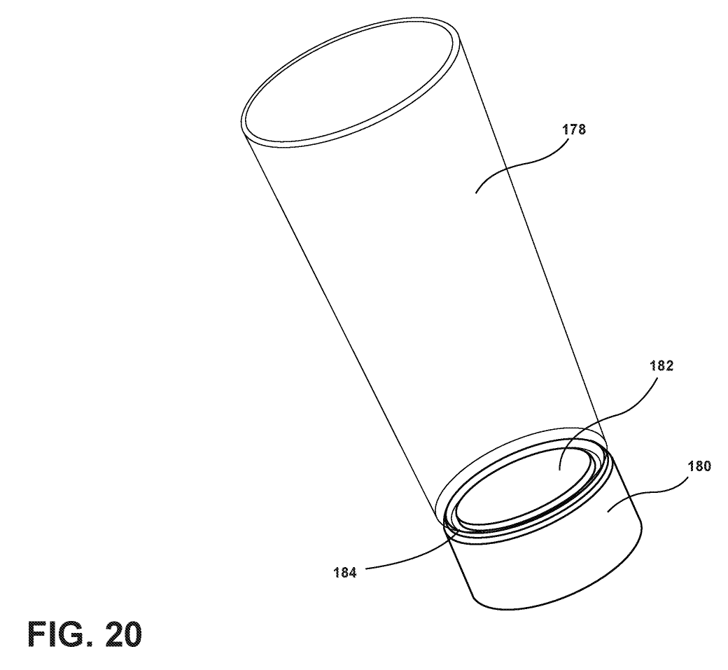

FIG. 20 shows a decorative lighting arrangement for a different embodiment of the invention. More specifically, FIG. 20 shows a transparent or translucent drinking glass 178 that mounts to a light emitting module 180 that has a top light emitting region 182 viewable through the drinking glass 178. The top light emitting region 182 includes a plurality of light emitting diodes (not shown).

A rim 184 is provided about the entirety of the top face of the light emitting module 180. The rim 184 is dimensioned to receive a cylindrical bottom of a drinking glass 178. In some embodiments, the rim 184 and at least the top of the light emitting module 180 is made of a stretchable/resilient or expandable/compressible material or other material that receives and is urged into contact with the outer edge or lower outer wall of the drinking glass 178. In this manner, the light emitting module 180 is attached to the drinking glass 178 to form a single unit, and detached from the drinking glass 178. In another embodiment, the light emitting module 180 is a coaster that receives the drinking glass 178.

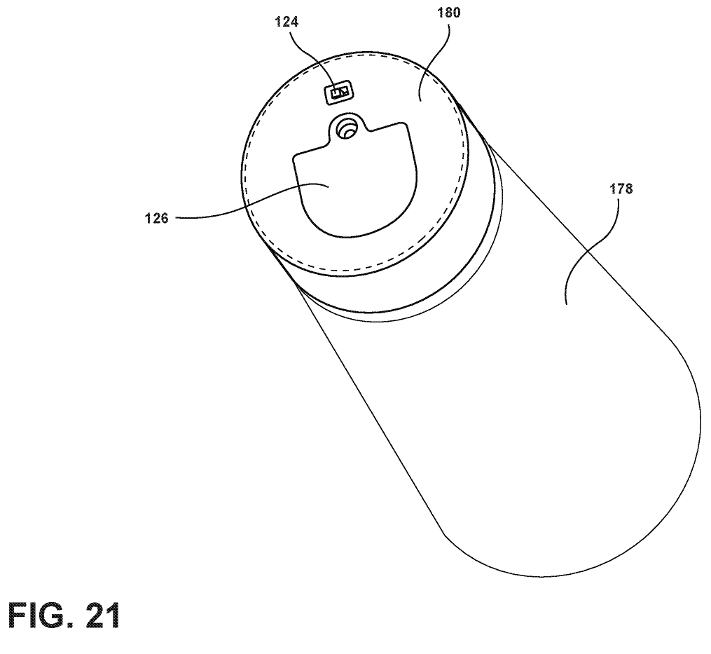

FIG. 21 shows a bottom side of the light emitting module 180. The light emitting module 180 includes an ON/OFF switch 124 and a battery cover 126 for removal and storing batteries. While a push button switch is not shown secured to the battery cover 126, a push button switch as in the embodiments shown in FIGS. 14-19 is contemplated.

In operation, the LEDs 162 provide illuminating light upwardly from the top light emitting region 182. The emitted light reacts with liquid and/or ice in the drinking glass 178 to obtain a desirable lighting effect. Thus, aesthetically pleasing lighting is the result.

The result is obtained from actuating the ON/OFF switch 124 shown in FIG. 21 that causes operation of the LEDs. Thus, the embodiment provides only one flash rate and lighting scheme. By providing the push button switch 130 shown in FIG. 15 and corresponding circuitry shown in FIG. 19, the light emitting module 180 operates in the same manner as in FIGS. 14-19.

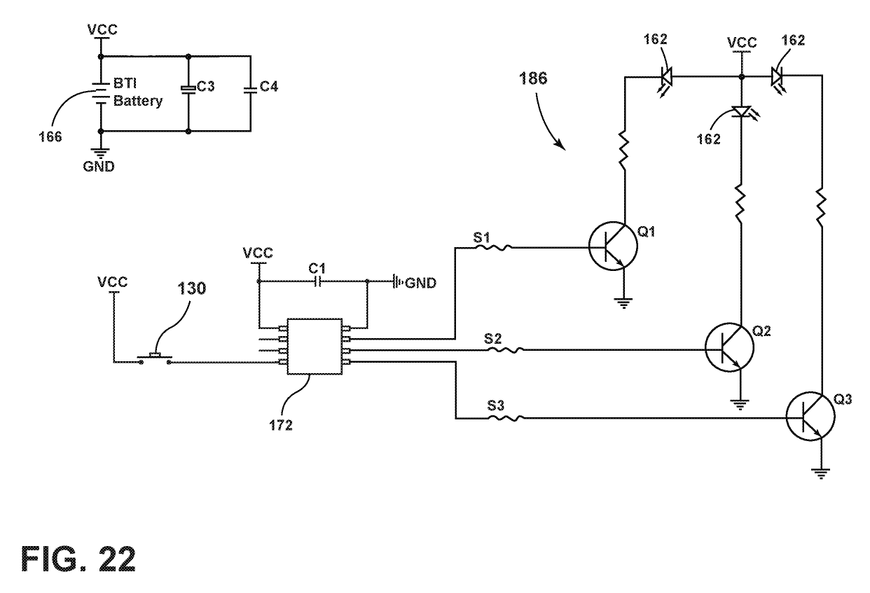

FIG. 22 shows a lighting circuit 186 for the drinking glass embodiment. The lighting circuit 186 is identical to the lighting circuit 170 shown in FIG. 19, except only three light emitting diodes 162 are shown. Thus, the lighting circuit 186 operates in the same way as the lighting circuit 170 of the toy 100.

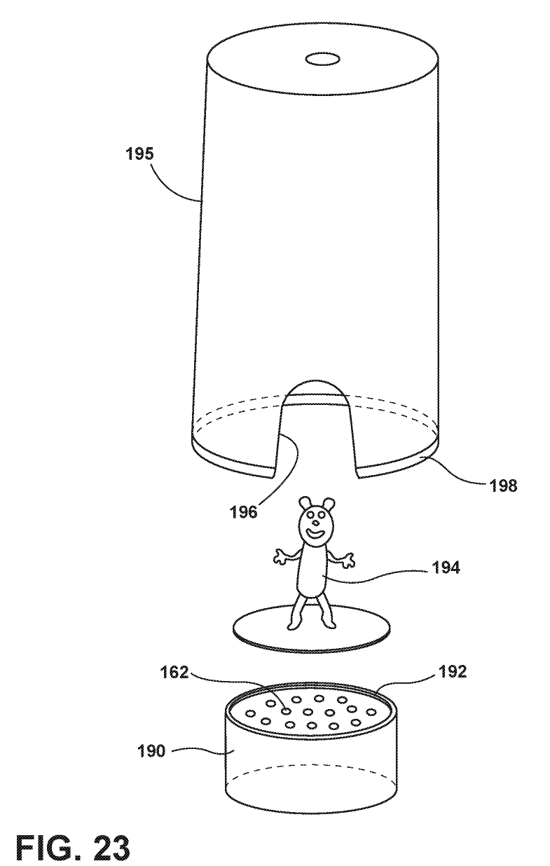

FIG. 23 shows another embodiment of the invention wherein a light emitting module 190 includes a top region with an annular rim 192 about the entirety thereof. The annular rim 192 includes threads for attachment. LEDs 162 are disposed at the top region of the light emitting module 190 for projecting light upwardly.

A figurine 194 shown in FIG. 23 has a widened base provided for placement on the top region of the light emitting module 190. A drinking glass 195 includes a rounded opening or aperture 196 with a dome shape. Further, the drinking glass includes a threaded edge 198 on the outer wall and about the entirety of the bottom or lower edge thereof as shown in FIG. 23.

Before operation, the figurine 194 is placed upon the top region of the light emitting module 190 and the drinking glass 195 is placed thereon, wherein the figurine is disposed within the dome or aperture 196. Thereafter, the drinking glass 195 is rotatably secured by the threaded edge 198 thereof and the threads on the annular rim 192 of the light emitting module 190 to form an integral unit.

The arrangement of FIG. 23 includes essentially the same lighting circuit 170 as shown in FIG. 19. Therefore, the lighting operation of the figurine 194 with the drinking glass 195 shown in FIG. 23 is essentially the same as the first drinking glass embodiment disclosed above, except the figurine 194 will be illuminated in various ways to provide entertaining effects. In these embodiments, the article is a non-wearable article

In another embodiment, the light emitting module is similar to the light emitting module 180 for use with a drinking cup shown in FIG. 20 and the light emitting module 190 shown in FIG. 23, except the entire module is waterproof. Thus, in this embodiment the light emitting module can be utilized in a bathroom as a light up projector for liquid soap containers, bath gel containers, or the like. In some embodiments, only flashing and/or changing color light is provided.

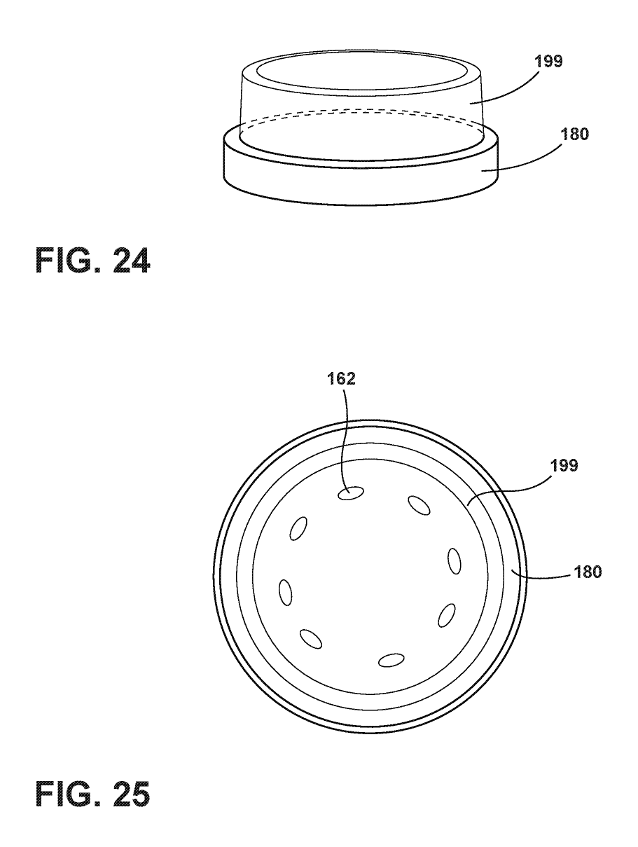

FIGS. 24 and 25 show another embodiment of the drinking cup embodiments shown in FIGS. 20-23. In FIG. 24, the light emitting module 180 has an open bore article receiver 199 mounted thereon. The open bore provides a path for light from the light emitting module 180 to enter a transparent or translucent container disposed therein. The article receiver 199 has a narrower diameter than the light emitting module 180 and is secured to the top side thereof. The securement is by adhesives, fasteners or any other known attachment method.

As shown in FIG. 25, a pattern of light emitting diodes 162 are shown on the top of the light emitting module 180. The push button switch (not shown) is disposed at the bottom side of the light emitting module. In some embodiments, the push button switch is located on the top of the light emitting module and surrounded by the light emitting diodes 162. Thus direct contact of a transparent or translucent container with the push button switch actuates the light emitting module 180.

The open bore article receiver 199 is formed as a stretchable material. The height, width and shape of the article receiver 199 is variable for fitting different types and sizes of drinking cups or other articles received therein. In some embodiments, the article receiver 199 is made of a stretchable/resilient or expandable/compressible material or other material that receives and is urged into contact with the outer edge or lower outer wall of a drinking glass or other article.

While shown as a necessary attachment for receiving a glass, a bottle, a cup or other container, in some embodiments, an article receiver 199 is not required. Instead, in some embodiments, the light emitting module 180 functions as a drinking coaster that provides illumination properties without an article receiver.

Thus, the invention provides, among other things, a novel approach to providing a variety of aesthetically pleasing lighting effects and features for a variety of articles, such as, for example, a toy, a backpack, a drinking glass, and a drinking glass with a figurine. Further, other arrangements are contemplated as discussed below.

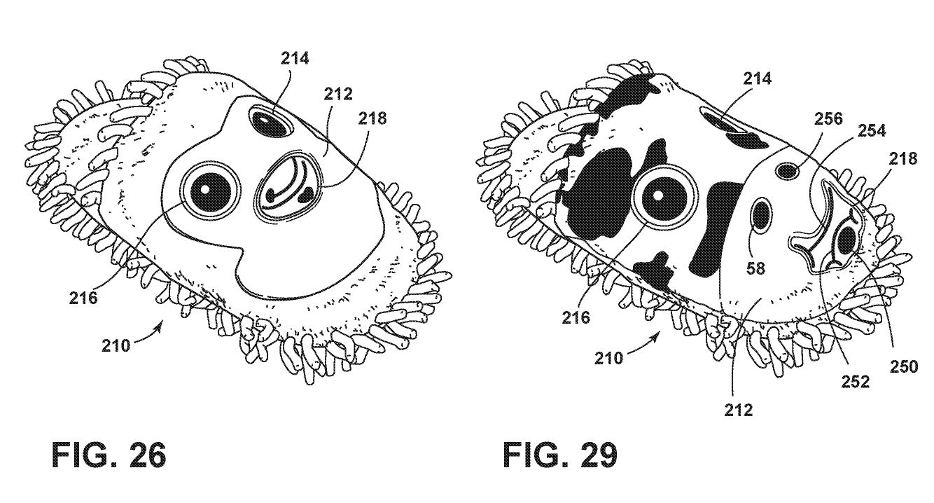

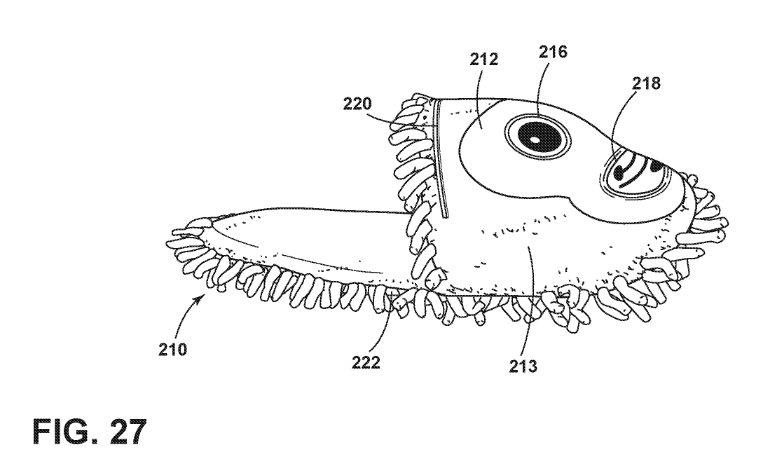

FIGS. 26 and 27 illustrate a wearable article or footwear 210 that includes a front top member 212 supported on a foot article body 213. The front top member 212 includes first and second openings 214, 216 and a third opening 218. The front top member 212 typically is a soft cloth or cloth-like material. Further, FIG. 27 illustrates a recess, a pocket or other type of suitable enclosure or compartment (hereinafter collectively referred to for convenience as a “recess 220”), disposed near a rear edge of the front top member 212 and extending interiorly and frontwardly within the footwear 210. The openings 214, 216, 218 open into the recess 220. The wearable article 210 may include a fastener (not shown) to at least partially close the recess. FIG. 27 also shows a sole 222 secured to the foot article body 213 for supporting a foot of a wearer.

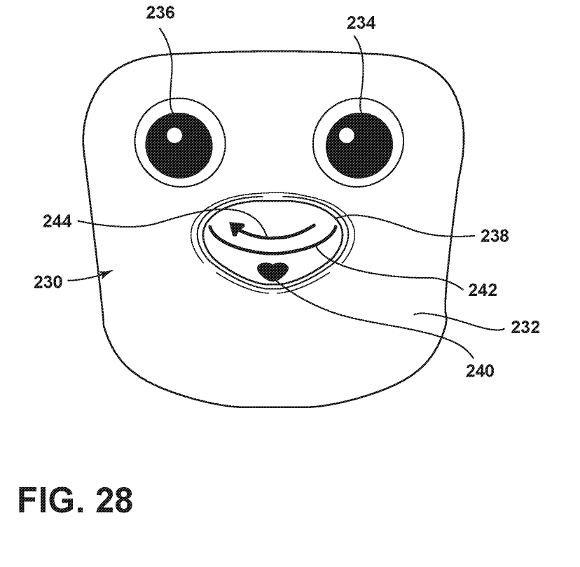

FIG. 28 illustrates a lighting module 230 including a housing 232. The housing 232 typically is a hard shell plastic material for fitting within the recess 220 of the footwear 210. The housing 232 may be made of different materials. In one embodiment, the housing 232 is made from flexible, durable, and transparent material. The housing includes a first region 234 and a second region 236 each comprising indicia in the shape of an eye for outputting light energy. Finally, a third region 238 includes indicia corresponding to different expressions. More specifically, in one exemplary embodiment shown in FIG. 28, the indicia include heart indicia 240, smile indicia 242 and arrow smile indicia 244 with an arrow at one end. The indicia are intended to indicate facial expressions for a face of an animal, person, toy character, or other type of character. In other embodiments, the indicia may represent other animated characteristics or features or symbols. The third region 238 may correspond, for example, to a mouth or nose for various characters.

FIG. 29 shows another embodiment of the invention similar to the arrangement shown in FIG. 26. One difference is that the third opening 218 has a different non-symmetrical shape. Further, the indicia provided in the third region of the lighting module 230 and viewable in FIG. 29 differs from the FIG. 26 embodiment. More specifically, an elliptical shaped indicia 250, a frown shaped indicia 252 and a non-symmetrical smile indicia 254 are illustrated in FIG. 29. Further, the front top member 212 includes indicia representing nostrils 256, 258 and other decorative indicia shown in FIG. 29.

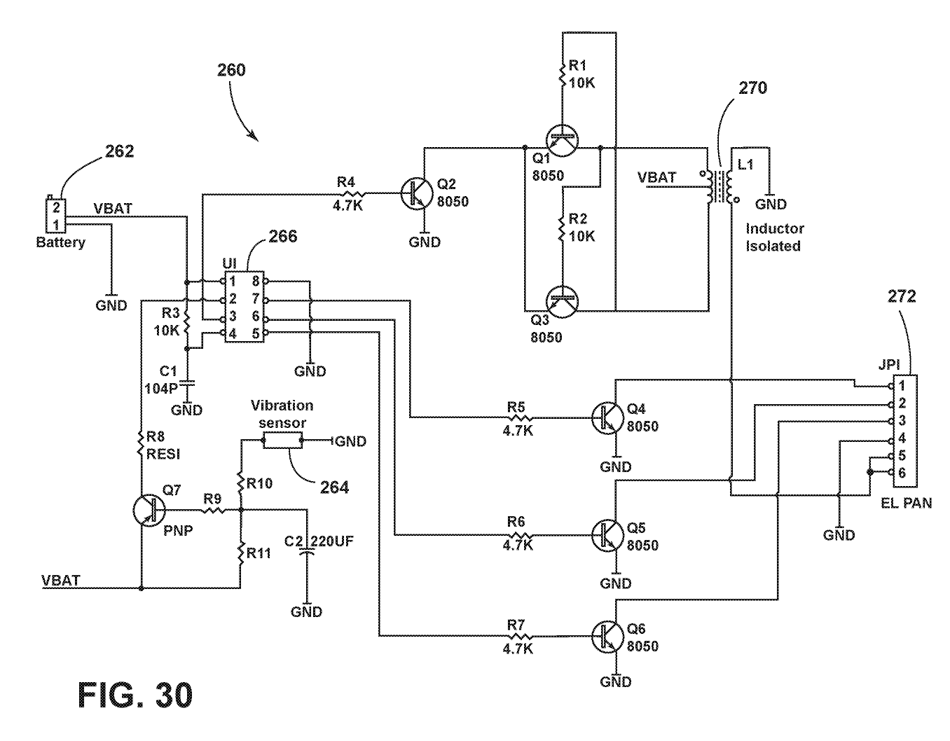

The lighting circuit 260, as shown in FIG. 30, includes a battery 262 provided as a power source, a motion or vibration sensor 264 and a controller 266. The controller 266 can be a processor, such as a digital processor, although ASIC circuits and other analog arrangements are contemplated. In one embodiment, the controller is a 8051 microprocessor. The motion sensor 264 connects to pin 2 of the controller 266 via a circuit path that includes battery voltage, bridge resistors, a capacitor and a transistor Q7. In some embodiments, the motion sensor 264 is a vibration sensor or a force sensor for sensing impact of a foot of a wearer with a floor. A sound sensor and other types of sensors that can be manipulated by a user are also contemplated.

The battery 262 provides power to circuitry including the motion sensor 264, the controller 266 and to an isolation inductor 270. As shown in FIG. 30, the isolation inductor 270 is connected via transistors and resistors to input 3 of the controller 266. The isolation inductor 270 is connected to a lamp panel 272 to provide power thereto. The lamp panel 272 is connected to a plurality of lamps (not shown). In some embodiments, the lamps are light emitting diodes.

Outputs 5-7 of the controller 266 connect to inputs 1-3 of the lamp panel 272 via respective transistors Q4-Q6. Each of the outputs 5-7 control lamps in the first and second regions of the lighting module 230 and selectively control the three lamps provided in the third region.

Operation

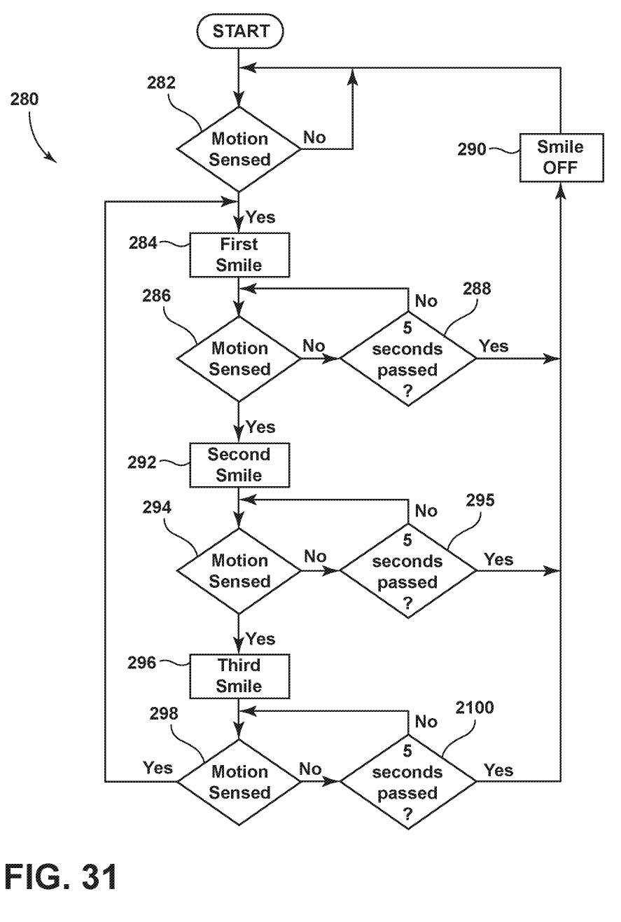

FIG. 31 illustrates a flowchart 280 that graphically represents the operation of one embodiment of the lighting circuit 260. At first, when the battery 262 is placed to power the lighting circuit 260 (in the embodiment shown in FIG. 30 there is no on/off switch, although one is contemplated), the motion sensor 264 is activated to detect motion and provide a motion signal to the processor 266. At step 282, the processor 266 determines whether a motion signal is output by the motion sensor 264. If no motion signal is received, the processor 266 repeats the step 282 for sensing the presence of a motion signal. In the event that motion is sensed, the program advances to step 284. At step 284, the processor provides an output on one of the pins 5-7 to the lamp panel 272 via the corresponding one of the transistors Q4-Q6. The lamp panel 272 provides outputs to lamps (not shown) that output light from the first and second regions 234, 236 that act as eyes of the character that is incorporated into the front top member 212 of the foot wear 210. The light in the FIG. 28 embodiment illuminates the area about the perimeter of the eye indicia. In other embodiments, the eye itself is illuminated. Simultaneously with the eye indicia being illuminated, the lamp panel 272 provides an output to a lamp that illuminates the heart indicia 240 shown in FIGS. 26 and 28. Thus, a facial expression is provided for the front top portion 212 of the foot wear 210. The light provided to the eye indicia located in the respective regions 234, 236 and heart indicia 240 can be constant, but typically is blinking or operated in an on/off manner. Further, in some embodiments the on/off frequency or flashing rates of the eye indicia in the regions 234, 236 and the heart indicia 240 are different.

After the first facial expression begins, a timer with the controller starts, and the routine 280 advances to decision step 286. At decision step 286, the controller 266 determines whether a motion signal is again provided by the motion sensor 264. If not, the routine advances to step 288. At step 288, the processor determines whether five seconds have passed since the first facial expression started. If the time has not passed, the routine returns to step 286. When five seconds has passed, the routine 280 advances to step 290. At step 290, the illumination of indicia ends. Thereafter, the routine 280 advances to decision step 282 and begins operation of the routine from the start.

In the event that motion is sensed at decision step 286, while the first expression is being displayed, the routine advances to step 292. At step 292, the controller 266 provides an output on a different one of the pins 5-7 to the lamp panel 272 via the corresponding one of the transistors Q4-Q6. The lamp panel 272 provides or maintains outputs to lamps (not shown) that output light from the first and second regions 234, 236 that act as eyes of the character that is incorporated into the front top member 212 of the foot wear 210. Further, the lamp panel 272 stops operating the lamp illuminating the heart indicia 40 shown in FIGS. 26 and 28 and instead switches power to a lamp that illuminates the smile indicia 242. Thus, the second actuation of the motion sensor 264 within a predetermined time, in this instance five seconds, results in a change in the expression of the character or image provided on the front top portion 212 of the foot wear 210.

The routine 280 then advances to decision step 294. At step 294 the controller again determines if a motion signal is present. If no motion signal is present, the routine 280 advances to decision step 296. At step 296, the controller 266 determines whether a predetermined time, such as five seconds, has passed since the second expression began. If the time has not passed, the routine 280 returns to decision step 294. If the five seconds has passed, the routine advances to step 290. Thereat, power to the lights illuminating the expression is ended and the routine 280 advances to step 282 and restarts the routine.

Returning to decision step 294, if motion is sensed the routine advances to step 296. At step 296, the controller 266 provides an output on the last unused one of the pins 5-7 to the lamp panel 272 via the corresponding one of the transistors Q4-Q6. The lamp panel 272 provides or maintains outputs to lamps (not shown) that output light from the first and second regions 234, 236 that act as eyes of the character that is incorporated into the front top member 212 of the foot wear 210. Further, the lamp panel 272 stops operating the lamp illuminating the smile indicia 242 shown in FIGS. 26 and 28 and instead switches power to a lamp that illuminates the arrow smile indicia 244. Thus, at step 296 a third facial expression is provided for the character incorporated into the front top member 212.

After step 296, the routine 280 advances to decision step 298. At step 298, the controller 266 determines whether a motion signal is output by the motion sensor 264. If a motion signal is received the routine advances to step 284 and the controller 266 operates to provide the first facial expression as discussed above.

If no motion is sensed at step 298, the routine 280 advances to decision step 2100. At step 2100 if less than five seconds has passed the routine 280 returns to decision step 298 to sense motion. When five seconds has passed, the routine 280 advances to step 290 and power to the lights ends. Thereafter, the routine 280 advances to decision step 282 and operation of the routine restarts.

While steps 284, 292, 296 are labeled “first smile”, “second smile” and “third smile” in FIG. 31, the steps include any expression. The term “expression” as used herein includes symbols and other animated characteristics and features, and not merely facial expressions. Further, the order that the indicia 240, 242, 244 are illuminated can be changed by programming of the controller 266. Different sequences are contemplated to provide different appearances. For example, the controller 266 can be programmed to provide a sequence to illuminate indicia 240, then illuminate indicia 240, 242, and subsequently indicia 242 alone, followed by indicia 242, 244. Other sequences are contemplated. For example, a sequence providing smile, smile, wink, smile, wink, wink, smile is contemplated for a foot wear 210 having facial expressions.

Likewise, the time period of five seconds shown in FIG. 31 is adjustable by programming the controller 266 for each of the three stages and providing different time periods for each stage are contemplated. The controller 266 also is programmable to provide different flash rates for the lamps corresponding to the eye indicia depending on which of the first, second and third indicia is being displayed and the flash rate of the first, second and third indicia can vary. Further, a continuous illumination is also contemplated.

While the wearable article shown in FIGS. 26, 27 and 29 is footwear, in some embodiments, the article is a shirt, pants or other clothing having a recess to receive the lighting module 230 and openings for outputting light. In yet other embodiments, the article may be a toy such as toy FIG. 100 or another type of article such as bedding. The lighting module 230 is easily removed from foot wear 210 to move to a different wearable article 214 or to allow washing of the previously used foot wear 210. While one foot wear 210 is shown in FIGS. 26 and 29, the invention is intended to have two articles of foot wear, each receiving a lighting module 230 and operating the same way. In some embodiments, a wearable or other type of article includes multiple lighting modules used at the same time in multiple recesses, or in a recess designed to hold two or more modules. Of course, a lighting module 230 may be removed from a recess and once outside the wearable article 210, the battery 262 of the lighting module 230 can be easily changed.

In some embodiments, the front top member 212 of the wearable article 210 includes a light transmissible plush character for displaying the changing facial expressions of the lighting module 230. In other embodiments, the wearable article 214 includes a light transmissible window (not shown) instead of an opening for displaying the indicia of the lighting module 230. The lighting module 230 in the regions 234, 236, 238 includes a cover arrangement to provide the indicia and to prevent light from directly exiting therefrom. The light output from the lighting module 230 can be of any chosen color. Further, the three indicia provided in the third region 238 can each have a different color.

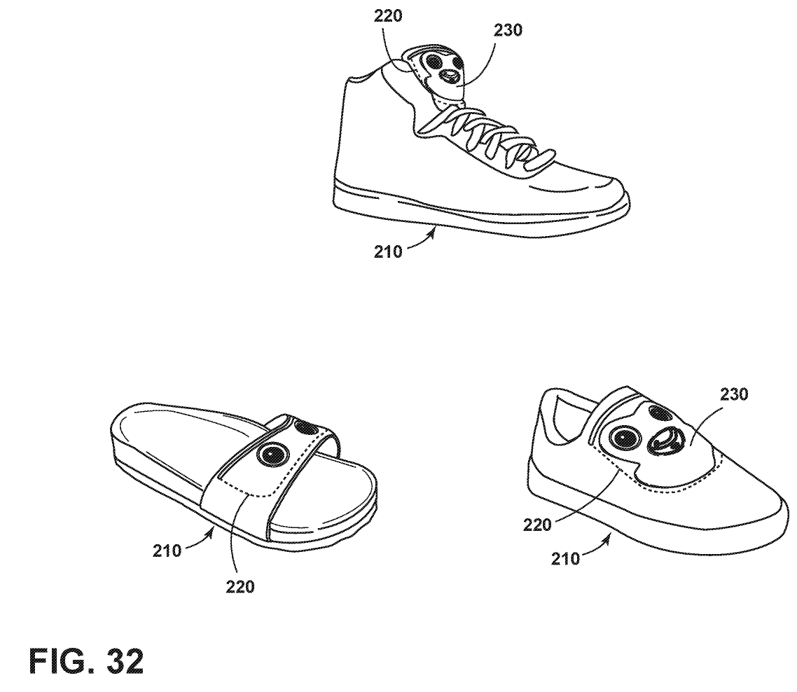

The foot wear 210 can also include various types of shoes. FIG. 32 shows foot wear 210 as a sandal, a tennis shoe, and a casual shoe each having a recess 220. A lighting module 230 has indicia provided on the foot wear that operates in the manner discussed above.

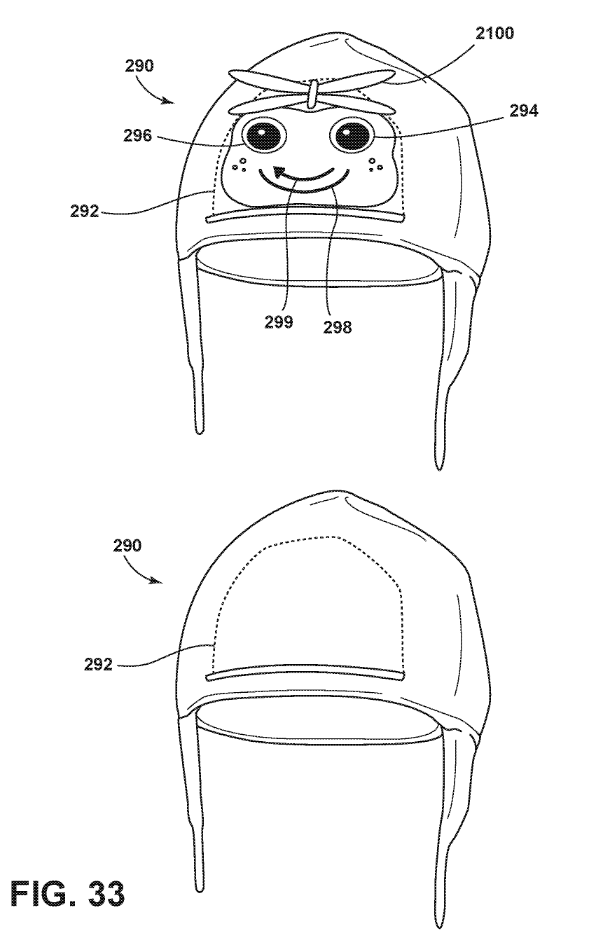

FIG. 33 shows a different embodiment for the wearable article, wherein the article is a hat or cap 290. The hat includes a recess 292 to receive the lighting module 230. Through an aperture or apertures provided with the pocket or recess, or a transparent window, first and second regions 294, 296 of the lighting module 230 are provided as eye indicia. Further, a third area is provided with expressions 298, 299. Other areas, including a character element, can include lamps to provide expressions and other indicia in the manner as discussed above.

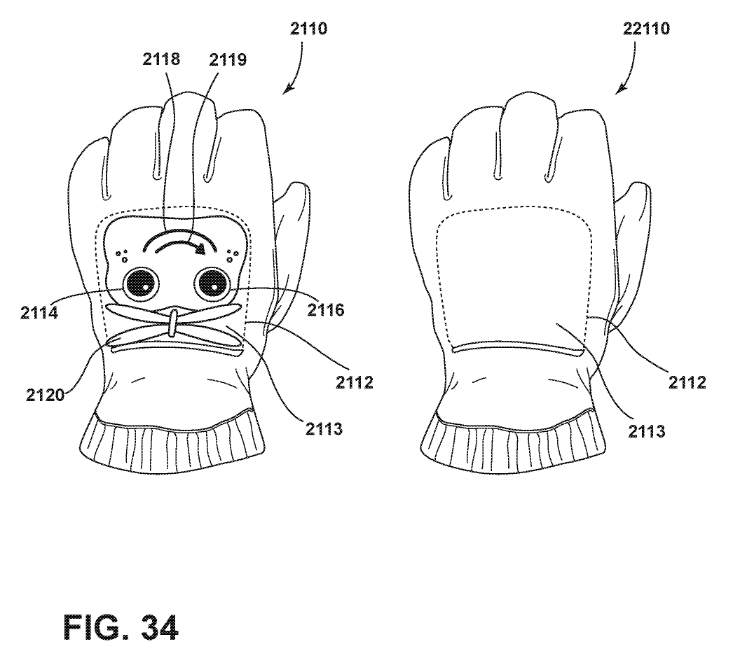

FIG. 34 shows a different embodiment, wherein the wearable article is a glove 2110. The glove 2110 includes a pocket or recess 2112 for receiving a lighting module. A transparent window 2113 can be provided instead of aperture(s) through an opaque material that open into the recess 2112. As in earlier embodiments, regions 2114, 2116 of a lighting module are shown. Further, expressions 2118, 2119 and a character element 2120 are provided with lamps. The lamps operate in a manner as discussed above.

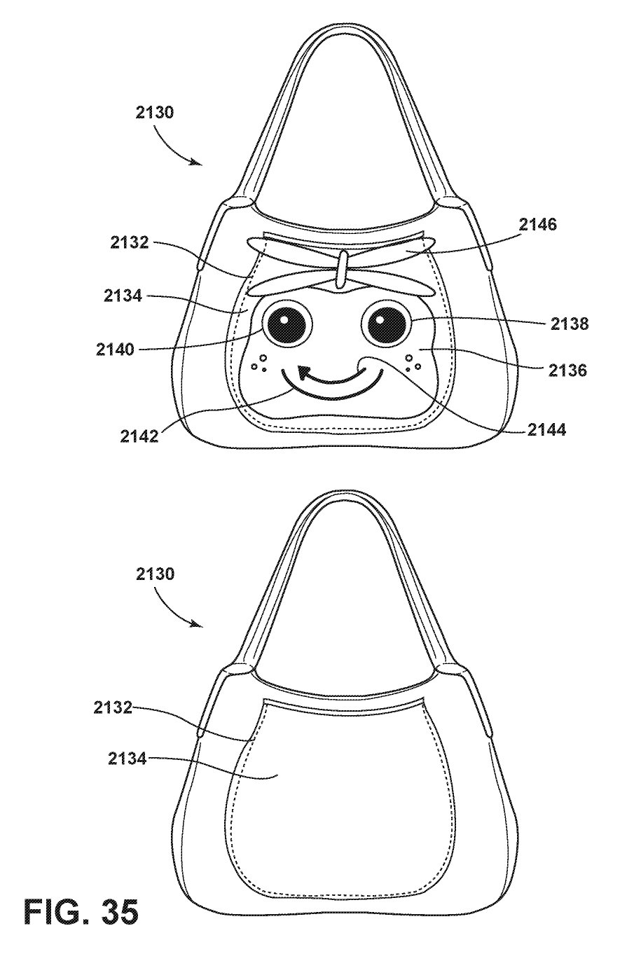

FIG. 35 illustrates a different embodiment in which the wearable article is a bag 2130 that includes a recess 2132 and a light transmissible window 2134. A lighting module 2136 visible through the window 2134 includes regions 2138, 2140 provided for eyes or other indicia and expressions 2142, 2144, along with a character element 2146 that also can be provided with lamps.

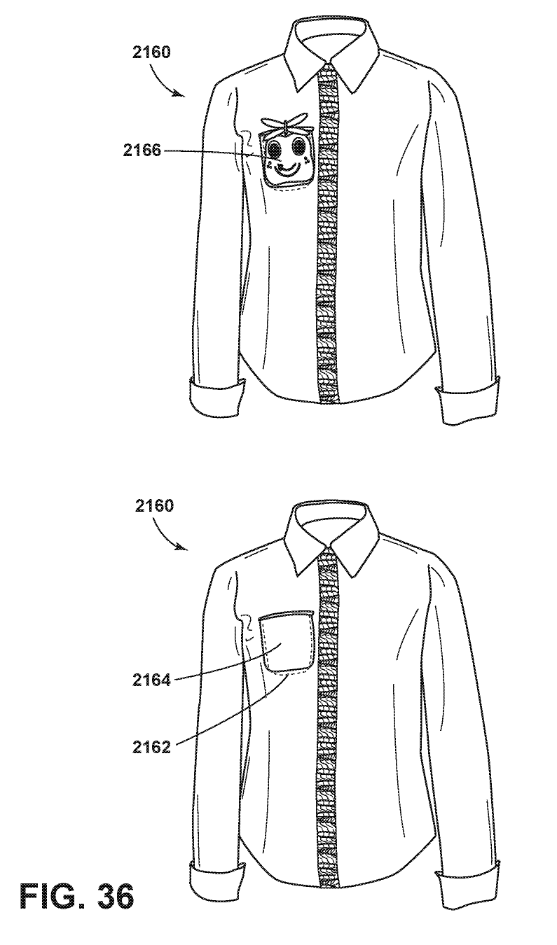

FIG. 36 illustrates a different embodiment in which the wearable article includes a jacket 2160 with a recess 2162 and a transparent window 2164. The jacket receives the lighting module 2166 in the recess 2162. As in the other embodiments, the lighting module 2166 includes expressions.

Thus, the invention provides, among other things, a multi-expression lighting module that allows for different expressions for a character provided on an article that can be selectively manipulated by motion or otherwise activated by a manual switch.

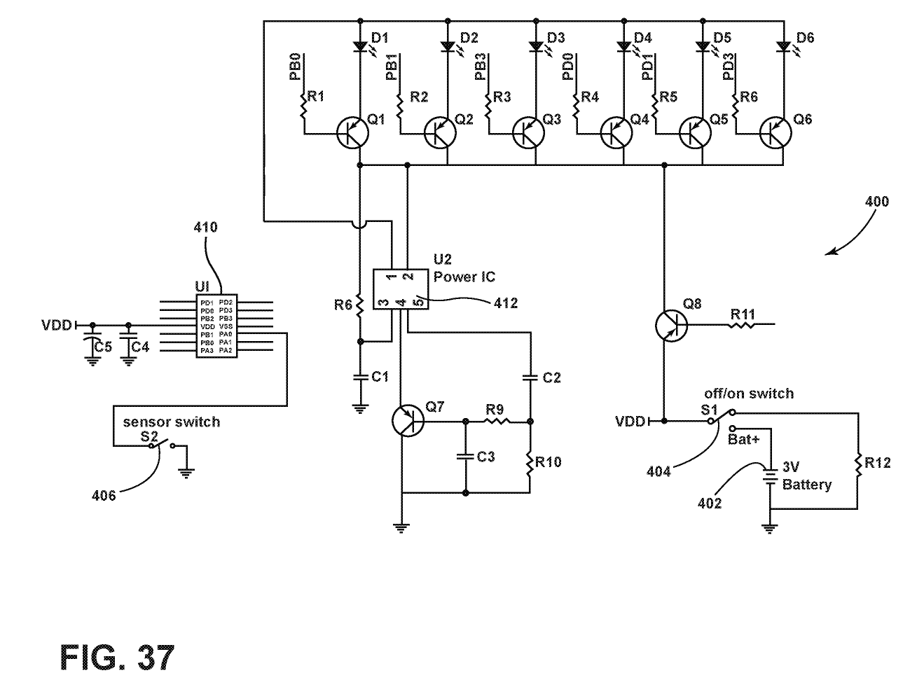

The lighting circuit 400 shown in FIG. 37 is similar to and operates in a similar manner as the lighting circuit in FIG. 30 above. The lighting circuit 400 includes a battery 402 provided as a power source and an ON/OFF switch 404 to disconnect/connect power to the lighting circuit 400. A motion or vibration sensor 406 connects to a controller 410 via input/output pin PA0. Inputs and outputs of the controller are labeled and connect to parts of the circuit having similar labels. The controller 410 can be a processor, such as a digital processor, although ASIC circuits and other analog arrangements are contemplated. In one embodiment, the controller is a SOP14 processor. In some embodiments, the motion sensor 406 is a vibration sensor or a force sensor. In other embodiments, the sensor is a sound sensor. Further, other types of sensors that can be manipulated by a user are also contemplated.

The battery 402 provides power to circuitry including the motion sensor 406 via the controller 410 and to a power integrated circuit 412 via a transistor Q8. The transistor Q8 is controlled by output PA2 of the controller 410. The transistor Q8 and resistor R11 act as an EL power supply to the electroluminescent lights (EL) D1-D6.

As shown in FIG. 37, outputs PB0-PB2 and PD0-PD2 from the controller 410 control respective transistors Q1-Q6 to selectively operate the respective EL lights D1-D6 or light emitting diodes.

The EL lights D1-D6 are controlled in a similar manner to the lights disclosed above and shown in FIGS. 30 and 31. The lighting circuit 400 provides power to the display units discussed below.

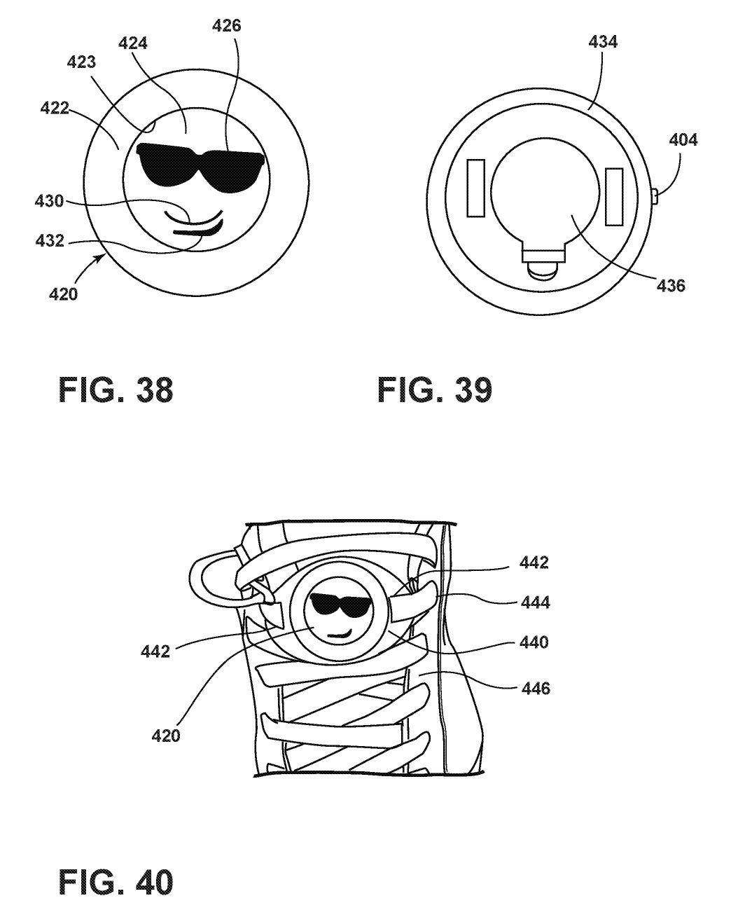

FIGS. 38 and 39 show a display unit 420, such as to display or depict an emoticon-type character or expression. FIG. 38 shows a front view of a display unit 420 including a housing 422 having an opening 423 for display of a character or other image 424, such as an emoticon-type character or expression. The display includes indicia 426, 430, 432. FIG. 39 is a rear view of the display unit 420 having a rounded annular outer edge 434 and a removable battery cover 436. An ON/OFF switch 404 is a slider switch that allows a user to disable the display unit 420 to save battery charge.

In operation, the display unit 420 operates in a similar manner to the embodiment disclosed in FIGS. 26-31 above. Upon detection of motion by motion switch 406 shown in FIG. 37, a motion signal is provided to the controller 410. In the event that motion is sensed, the controller 410 provides an output on one or more of the pins PB0-PB2, PD0-PD2 to selectively actuate EL lights D1-D6. The lights D1-D6 selectively output light to the respective indicia 426, 430, 432 of the display 424. As shown in FIG. 38, the indicia 426 represents sunglasses and the indicia 430, 432 represent facial expressions of a mouth. The light provided to the various indicia 426, 430, 432 can be constant, but typically is blinking or operated in an on/off manner at various flashing rates. The indicia 426, 430, 432 may be illuminated separately or jointly to provide, for example, different facial expressions, symbols, or other patterns for a character or other type of image.

In some embodiments, after the first facial expression begins, a timer with the controller 410 starts counting, and the controller 410 determines whether a motion signal is again provided by the motion sensor 406. If not, the controller 410 determines whether five seconds have passed since the first facial expression started. If five seconds have passed without motion sensing, the illumination of indicia 426, 430, 432 is extinguished. Thereafter, the controller 410 begins detecting operation of the motion sensor 406.

In the event that motion is sensed within five seconds or less, the controller 410 advances from a first expression with indicia 430 illuminated to a second expression with indicia 430 off and indicia 432 illuminated by switching the lights D1-D6 that are operating. Thus, the expression of the display 424 changes.

In some embodiments, a third or additional expressions are provided by additional lights and additional indicia. In other embodiments, the display 424 has a single expression or image. In some embodiments, the indicia of the display 424 is flashed for different time periods or provided as constant light. In some embodiments, the color of the light changes by the actuation of different lights D1-D6.

FIG. 40 shows a shoe mounted embodiment for the display unit 420. A flexible oval-shaped mounting element 440 is secured to the back side of the display unit 420. The mounting element 440 includes opposing apertures 442 oriented at the sides of the display unit 420. A shoe string 444 is advanced through the apertures 442 to secure the display unit 420 to a shoe 446. The display unit 420 operates in response to motion detection as discussed above.

In other embodiments, the mounting element 440 receives a bracelet, anklet or necklace through the apertures 442 to secure the display unit 420 to a wrist, a foot or a neck of a wearer.

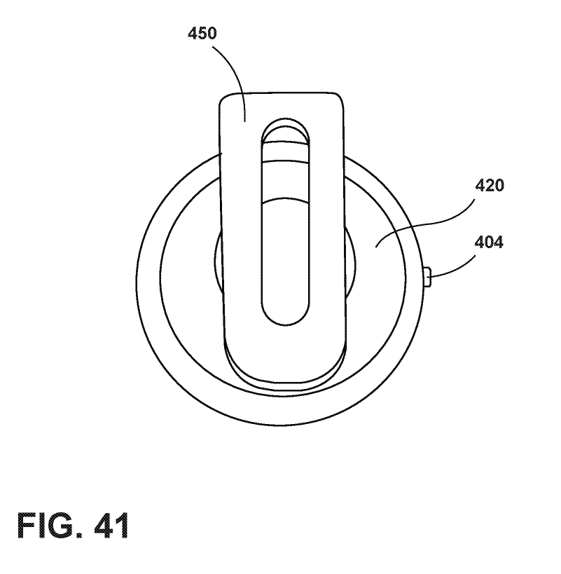

FIG. 41 shows a rear view of a display unit 420 having a clip 450 attached to or molded therewith. The top end of the clip 450 is flexible to some degree for enabling securement of the display unit 420 to a headband, shirt collar, pocket, belt, backpack or any other desired suitably shaped object. The display unit 420 may also be integrated with, assembled as part of, or otherwise included as a component of another article, such as a backpack, belt, pillow, drinking glass, or article of clothing.

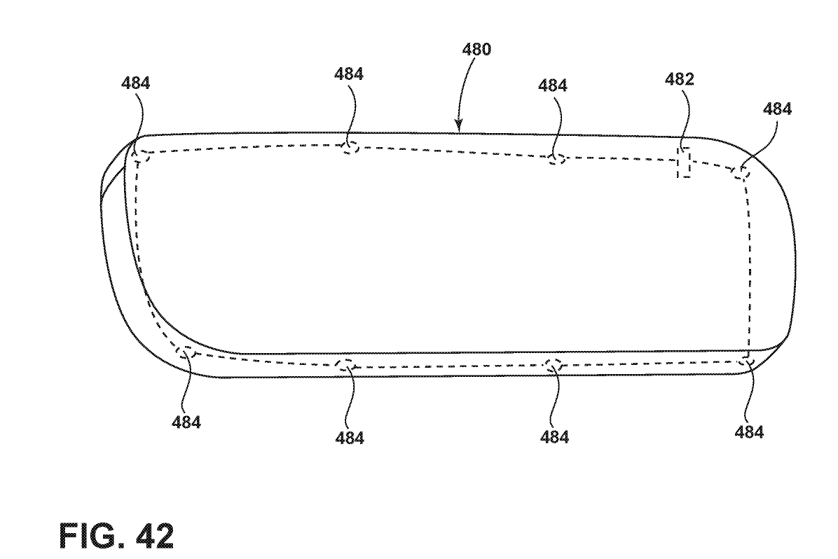

In yet other embodiments, the article may be a type of bedding 480 as shown in FIG. 42. For instance, an arrangement can be provided with bedding 480 that acts as an air mattress in one embodiment. The bedding 480 has an elongate, rectangular shape with the dimensions of a sleeping bag or other sized bedding. In one embodiment, the bedding 480 has an inflatable located therein that extends essentially the entire length and width thereof. In the embodiment shown, a light emitting module 482 connects with LEDs 484 spaced about the sides of the bedding 480. The LEDs are wired in series with each other. In some embodiments, the light emitting module 482 includes a switch for operating the LEDs 484. As shown in the FIG. 42 embodiment, opposing LEDs 484 are spaced along opposing edges of the bedding 480 and spaced along the length thereof. Thus, the LEDs 484 are not disposed in the light emitting module 482 in this embodiment, but are arranged externally to provide light to substantially the entire bedding 480 via the inflatable. The outer layer of the bedding 480 permits light from the LEDs 484 to pass therethrough to provide a pleasant lighting effect when actuated. The light emitting module 482 may be located at a corner of the slumber bed for ease in locating to control the LEDs 484, near a corner as shown in FIG. 42 or elsewhere. In another embodiment, foam is provided within the bedding 480 instead of an inflatable. Foam or foam material allows light to pass therethrough and through the external fabric or cover of the bedding 480 for pleasant viewing. In one embodiment, the light emitting module 482 is disposed between the foam and the outer layer. In another embodiment, the light emitting module is disposed within the foam. In one embodiment, the bedding is a slumber bed.

In one embodiment, a modular lighting system for wearable and other types of articles that move in response to movement of a wearer, the system comprising: a light module having a housing, the housing enclosing a lighting circuit, the lighting circuit including a motion or other type of switch, an electronic switch, a biasing circuit, and a plurality of multi-color lights, wherein the switch is configured to connect to a power source and change from an open state to a closed state in response to motion, user manipulation, or other external activity or factor, and wherein the biasing circuit biases the electronic switch, and the multi-color lights change colors according to a predetermined timing. The lighting system, wherein the multi-color lights include RGB LEDs.

A modular lighting system comprising: a plurality of wearable or other types of articles, each wearable article including one or more recess, each recess including a component through which light may pass; at least one light module having a housing, the housing configured to fit within the one or more recesses and enclosing a lighting circuit, the lighting circuit including a motion or other type of switch or sensor, an electronic switch, a biasing circuit, and a plurality of multi-color lights, wherein the motion or other type of switch is configured to connect to a power source and change from an open state to a closed state in response to motion, user manipulation, or other external activity, factor or force, and wherein the biasing circuit biases the electronic switch, and the multi-color lights change colors according to a predetermined timing. The lighting system, wherein the multi-color lights include RGB LEDs.

A lighting module for wearable and other types of articles that provides light in response to movement of a wearer includes a housing enclosing a lighting circuit, the lighting circuit including a power supply, a motion sensor or other type of sensor, a controller, a lamp panel and a plurality of lights connected to the lamp panel, wherein the housing includes first and second spaced regions each having a shape and a light to provide a display, and a third region that includes at least three lights, each of the lights being associated with one of first indicia, second indicia and third indicia in the third region. The sensor is configured to provide a signal to the controller in response to motion or other external activity, factor or force, and the controller provides an output to the lamp panel to selectively control the lights in response to the signal, the controller providing an output to power one of the at least three lights in the third region to display one of the first indicia, the second indicia and the third indicia. The indicia provided for the first and the second regions comprise eye indicia, and the lights of the first and the second regions provide illumination to flash light that is output about the eye indicia. The indicia in the third region provides first, second and third expressions for a character corresponding to the three indicia in the third region, each of the indicia corresponding to at least one of the lights, wherein the lights are selectively operated to illuminate the corresponding indicia. The third region has a mouth shape and at least two of the indicia of the third region correspond to facial expressions of a mouth. The lighting module is a portable removable lighting module adapted to be inserted into a recess in a front top region of foot wear, wherein the recess includes at least three openings, the three openings being positioned so that the first, the second and the third regions of the lighting module are viewable when the lighting module is received within the recess of the foot wear.

A wearable foot article with a lighting module comprises a sole, a foot article body and a front top member including a recess, the recess located near the foot opening of the foot article for receiving a foot of a wearer and extending toward a front of the foot article, the front top member including at least first, second and third openings; at least one light module having a housing, the housing configured to fit within the recess and enclosing a lighting circuit, the lighting circuit including a power supply, a motion sensor, a controller, a lamp panel and a plurality of lights connected to the lamp panel, wherein the housing includes first and second spaced regions having an elliptical shape and each of the regions having at least one of the lights to provide a display, and wherein the housing includes a third region provided with indicia and that includes at least three lights for providing a display, wherein the first and second spaced regions are in alignment with the first and second openings, and the third region is in alignment with the third opening during use, wherein the plurality of lights project light from the foot article through the openings. In one embodiment, the motion sensor is configured to provide a motion signal to the controller in response to motion, and the controller provides an output to a lamp panel to selectively control the lights in response to the motion signal. Indicia provided for the first and the second regions comprise eye indicia, and the lights of the first and the second regions provide illumination about the eye indicia. The indicia in the third region includes at least first indicia, second indicia and third indicia, each of the indicia corresponding to at least one of the lights, wherein the lights are operated to selectively illuminate one of the first indicia, the second indicia and the third indicia. The third region has a mouth shape and at least two of the indicia of the third region correspond to facial expressions of a mouth. A first one of the lights in the third region is actuated in response to motion detection by the motion detector, wherein a second detection by the motion detector within a predetermined time after the first detection operates a second one of the lights and deactivates the first one of the lights, and wherein a third detection by the motion detector within a predetermined time after the second detection activates a third one of the lights in the third region and deactivates the second one of the lights in the third region. The first light and the second light in the third region each illuminate different indicia corresponding to at least two different facial expressions. The motion sensor comprises a vibration sensor.

A lighting module for wearable and other types of articles comprises a lighting module having a housing, the housing enclosing a lighting circuit, the lighting circuit including a power supply, a sensor responsive to manipulation by a user, a controller, a lamp panel and a plurality of lights connected to the lamp panel, wherein the housing includes a first region having a shape and at least one light to provide a display, wherein the housing includes a second region that includes at least two lights, each of the two lights being associated with one of first indicia and second indicia in the second region to provide a display, wherein the sensor is configured to provide a sensor signal to the controller, and wherein the controller provides an output to the lamp panel to selectively control the lights in response to the sensor signal, the controller providing an output to power one of the at least two lights in the second region to display one of the first indicia and the second indicia. The second region has a mouth shape and the first indicia and the second indicia of the second region each correspond to a facial expression of a mouth. The first indicia and the second indicial indicia in the second region provide first and second expressions for a character corresponding to the two indicia in the second region, each of the indicia corresponding to at least one of the lights, wherein the lights are selectively operated to illuminate the corresponding indicia.

A display unit comprises a housing, the housing enclosing a lighting circuit, the lighting circuit including a power supply, a sensor responsive to manipulation by a user, a controller, and at least two lights, and a display provided on the housing, the display comprising at least first indicia and second indicia to provide an image, wherein the sensor is configured to provide a sensor signal to the controller, and wherein the controller provides an output to selectively control the lights in response to the sensor signal, the controller providing an output to power at least one of the at least two lights to display at least one of the first indicia and the second indicia. The image comprises a character, and wherein the at least first and second indicia comprise three indicia for providing first and second expressions for the character, wherein the controller selectively activates the lights to illuminate the three indicia to alternate between the first and second expressions. The character comprises an emoticon and wherein the display unit comprises an emoticon unit, and the expressions comprise a smiling image and a frowning image. A clip is provided for securement to an article. A mounting element with aperture can be provided for securement to an article. The sensor responsive to manipulation by a user may comprise a motion sensor.

Various features and advantages of the invention are set forth in the following claims.

What is claimed is:

1. A light emitting system for an article comprising:
a light emitting module having a housing, the housing enclosing a lighting circuit, the lighting circuit including a mode selecting switch providing an input to a controller, the controller providing outputs to selectively power at least one light emitting device connected thereto,
wherein a first mode comprises output of a single color and a second mode comprises at least one of changing color and flashing of the at least one light emitting device.

2. The light emitting system according to claim 1, wherein the light emitting system is free from a motion switch.

3. The light emitting system according to claim 1, wherein the light emitting module has a generally cylindrical disc shape and the mode selecting switch comprises a push button switch disposed on one side of the light emitting module.

4. The light emitting system according to claim 3, wherein the light emitting system comprises a toy with support elements, and wherein the light emitting module is disposed at a lower portion of the toy essentially between the support elements adjacent one of the support elements, and wherein the light emitting module is oriented for ease of actuation by a user applying downward force from a top of the toy.

5. The light emitting system according to claim 4, wherein the toy includes an essentially transparent inflatable object received within a fabric, the fabric including the support elements.

6. The light emitting system according to claim 1, wherein the light emitting module comprises a rim for receiving the bottom of a drinking glass to form an integral unit.

7. The light emitting system according to claim 6, wherein the rim of the light emitting module comprises a compressible material for receiving and urging against a lower outer edge of the drinking glass.

8. The light emitting system according to claim 6, wherein the rim includes threads thereabout to secure with threads provided on a lower outer edge of the glass, and the drinking glass includes an aperture or dome at a lower end thereof.

9. The light emitting system according to claim 8, comprising a figurine disposed with the aperture or dome of the drinking glass.

10. The light emitting system according to claim 1, wherein the at least one light emitting device comprises a plurality of light emitting diodes and the light emitting module comprises a coaster.

11. The light emitting system according to claim 1, wherein the article is bedding.

12. The light emitting system according to claim 1, wherein the light emitting system comprises a backpack with a pocket for receiving the light emitting module, the backpack having a fabric that permits light to pass outwardly and rearwardly from the backpack.

13. The light emitting system according to claim 1, wherein the light emitting system comprises a toy, wherein the light emitting module is disposed at a lower portion of the toy essentially between an essentially transparent inflatable object and a cover that receives the inflatable object and the light emitting module, wherein the light emitting module is oriented for ease of actuation by a user applying downward force from a top of the toy, and wherein upon actuation of the light emitting module the light emitted passes through the inflatable object and the cover to provide illumination of the toy.

14. The light emitting system according to claim 13, wherein the light emitting module has a generally cylindrical disc shape and the mode selecting switch comprises a push button switch disposed on one side of the light emitting module.

15. The light emitting system according to claim 1, wherein the light emitting system comprises a toy, wherein the light emitting module is disposed in the toy essentially between a foam and cover that receives the foam and the light emitting module therein, and wherein the light emitting module is oriented for ease of actuation by a user applying downward force from a top of the toy, and wherein upon actuation of the light emitting module the light emitted passes through the foam and the cover to provide illumination of the toy.

16. The light emitting system according to claim 15, wherein the light emitting module has a generally cylindrical disc shape and the mode selecting switch comprises a push button switch disposed on one side of the light emitting module.

17. A lighting module for wearable articles that provides light in response to movement of a wearer comprising:
a lighting module having a housing, the housing enclosing a lighting circuit, the lighting circuit including a power supply, a motion sensor, a controller, a lamp panel and a plurality of lights connected to the lamp panel, wherein the housing includes first and second spaced regions having a shape and each of the first and the second spaced regions having a light to provide a display, and wherein the housing includes a third region that includes at least three lights, each of the lights being associated with one of first indicia, second indicia and third indicia in the third region,
wherein the motion sensor is configured to provide a motion signal to the controller in response to motion, and
wherein the controller provides an output to the lamp panel to selectively control the lights in response to the motion signal, the controller providing an output to power one of the at least three lights in the third region to display one of the first indicia, the second indicia and the third indicia.

18. The lighting module as claimed in claim 17, wherein a first one of the lights in the third region is actuated in response to motion detection by the motion detector, wherein a second detection by the motion detector within a predetermined time operates a second one of the lights and deactivates the first one of the lights, and wherein a third detection by the motion detector within a predetermined time after the second detection activates the third one of the lights in the third region and deactivates the second one of the lights.

19. The lighting module as claimed in claim 18, wherein the first light, the second light, and the third light each illuminate different indicia corresponding to three different facial expressions for an image of a face.

20. A display unit comprising:
a housing, the housing enclosing a lighting circuit, the lighting circuit including a power supply, a sensor responsive to manipulation by a user, a controller, and at least two lights, and
a display provided on the housing, the display comprising at least first indicia and second indicia to provide an image,
wherein the sensor is configured to provide a sensor signal to the controller, and
wherein the controller provides an output to selectively control the lights in response to the sensor signal, the controller providing an output to power at least one of the at least two lights to display at least one of the first indicia and the second indicia.
